(19) United States
(12) Patent Application Publication
(10) Pub. No.: US 2024/0234123 A1
(43) Pub. Date: Jul. 11, 2024

(54) Method of Performing MS/MS of High Intensity Ion Beams Using a Bandpass Filtering Collision Cell to Enhance Mass Spectrometry Robustness

(71) Applicant: DH Technologies Development Pte. Ltd., Singapore (SG)

(72) Inventors: Bruce COLLINGS, Concord (CA); James HAGER, Concord (CA); Yang KANG, Richmond Hill (CA); Bradley B. SCHNEIDER, Bradford (CA)

(73) Assignee: DH Technologies Development Pte. Ltd., Singapore (SG)

(21) Appl. No.: 18/037,582

(22) PCT Filed: Nov. 17, 2021
(86) PCT No.: PCT/IB2021/060677

§ 371 Date: May 18, 2023

Related U.S. Application Data
(60) Provisional application No. 63/166,162, filed on Mar. 25, 2021.
(60) Provisional application No. 63/115,702, filed on Nov. 19, 2020.

(51) Int. Cl. H01J 49/42; H01J 49/00; H01J 49/24

(52) U.S. Cl. CPC H01J 49/4215; H01J 49/0031; H01J 49/24; H01J 49/0086

(57) ABSTRACT

A mass spectrometer comprises a first mass filter for receiving a plurality of ions and having a transmission bandwidth configured to allow transmission of ions having m/z ratios within a desired range, and a second mass filter that is disposed downstream of the first mass filter for selecting ions having a target m/z value within a transmission window thereof for mass analysis. The transmission bandwidth of the first mass filter encompasses at least two m/z ratios of interest such that one of said m/z ratios corresponds to said target m/z value within the transmission window of said second mass filter.

### RELATED APPLICATIONS

The present application claims priority to U.S. Provisional Application No. 63/166,162 filed on Mar. 25, 2021, entitled “Method of Performing MS/MS of High Intensity Ion Beams Using A Bandpass Filtering Collision Cell To Enhance Mass Spectrometry Robustness,” and U.S. Provisional Application No. 63/115,702 filed on Nov. 19, 2020, entitled “An Approach To Synchronize An Ion Guide With SWATH Acquisition,” which are incorporated herein by reference in their entireties.

### BACKGROUND

The present teachings are related to mass filters that can be utilized in a variety of mass spectrometers, as well as mass spectrometers in which such mass filters can be incorporated.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

Some mass spectrometer systems monitor multi-reaction-monitoring (MRM) transitions associated with analytes in a sample under study by using a mass analyzer to select precursor ions having a target mass-to-charge (m/z) ratio followed by fragmentation of the selected precursor ions to generate a plurality of product ions, which can then be mass analyzed.

In conventional systems, ions with different masses can be present in an ion guide positioned upstream of a mass analyzer with masses extending from a low mass cut-off of the ion guide and up in mass. For example, as shown schematically in FIG. 1, in such a conventional system, ions with masses of m₁, m₂, . . . , m₁₀ can be concurrently present in the upstream ion guide when the low mass cut-off of the ion guide is lower than m₁. In some cases, such a configuration can, however, lead to contamination of the downstream mass analyzer by unwanted ions.

A mass filter can be positioned upstream of the mass analyzer, where the mass filter provides a bandpass window that can limit the range of ions transmitted to the downstream mass analyzer, thereby reducing contamination of the mass analyzer and other downstream components by unwanted ions (i.e., ions whose analysis is not desired). Although the use of such a mass filter can reduce contamination, it can also reduce the speed at which MRM measurements can be made.

In particular, when the mass analyzer is transitioned to select the next precursor ion, the bandpass window of the upstream mass filter needs to be adjusted to allow transmission of the new precursor ion followed by re-filling of the mass filter. Thus, there is a need for enhanced methods of performing mass spectrometry, and particularly, a need for enhanced mass spectrometric methods that can be employed for MRM transition monitoring.

### SUMMARY

The present teachings relate to methods and systems for performing mass spectrometry in which the ion transmission bandwidth of an ion guide individually and/or in combination with the ion transmission window of a downstream mass analyzer are configured to perform tandem mass spectrometry while reducing, and preferably eliminating, the contamination of high-vacuum components of the mass spectrometer.

For example, in one aspect, the present teachings relate to performing a data-independent acquisition (DIA) tandem mass spectrometry method using a multipole ion guide of an ion guide chamber as a mass filter or prefilter. For example, the multipole ion guide can be configured to provide wider ion mass selection windows relative to the ion selection windows provided by a downstream mass filter utilized for performing DIA mass analysis.

### Ion Path Component Contamination Problem

Contamination of ion path components can affect the performance of a tandem mass spectrometer. Contamination tests on various experimental sample matrices (e.g. lipids, crashed plasma, tea/arugula matrix) indicate that the extent of debris buildup to performance degradation differs for various ion path components. In general, contamination on tandem mass spectrometer related regions, such as on the IQ1 lens or the Q1 quadrupole rods, is likely to cause greater performance degradation. Such performance degradation can be characterized, for example, by sensitivity loss or peak width changes due to charging.

When similar amounts of debris are accumulated on ion guide regions, such as the QJet® or the Q0 quadrupole, significantly fewer effects on performance degradation are observed. Therefore, it is desired to filter out unwanted species before high-vacuum (low-pressure) regions of a mass spectrometer so as to prevent contamination on these critical tandem mass spectrometer regions.

As described below, SWATH® acquisition is a DIA method where all precursor ions in a defined or selected Q1 precursor ion mass selection window are transferred to a fragmentation device (e.g., a collision cell) to generate one MS/MS spectrum. Also, the Q1 precursor ion mass selection windows are sequentially stepped (in conventional SWATH®) or scanned (in scanning SWATH®) across the entire precursor ion mass range of the analysis. In current SWATH® acquisition, during a Q1 scan for a selected Q1 precursor ion mass selection window, unwanted ions outside of the selected Q1 precursor ion mass selection window are filtered out and deposited onto Q1 rods.

In some tandem mass spectrometers, the MS/MS in SWATH® acquisition applies a fixed ion transmission control (ITC) of 100% to transit all ions into Q1 for precursor selection. This means that all ion currents outside of the precursor ion mass or m/z range are diverted to Q1 rods. This increases the rate of contamination, which, in turn, affects the system performance. For example, an increased rate of contamination adversely affects sensitivity and the shape of Q1 transmission windows. In particular, if the Q1 precursor ion mass selection windows become less square due to contamination, the transmission efficiency and coverage for the mass range of interest are reduced, which affects the ion extraction and quantitation accuracy.

As a result, additional systems and methods are needed to reduce the contamination of a tandem mass spectrometer when operating in a DIA mass analysis mode in order to maintain instrument sensitivity, precursor ion transmission efficiency, and coverage of the precursor ion mass range of interest.

### Tandem Mass Spectrometry and SWATH®

In general, tandem mass spectrometry, or MS/MS, is a well-known technique for analyzing compounds. Tandem mass spectrometry involves ionization of one or more compounds from a sample, selection of one or more precursor ions of the one or more compounds, fragmentation of the one or more precursor ions into product ions, and mass analysis of the product ions.

Tandem mass spectrometry can provide both qualitative and quantitative information. The product ion spectrum can be used to identify a molecule of interest. The intensity of one or more product ions can be used to quantitate the amount of the compound present in a sample.

A large number of different types of experimental methods or workflows can be performed using a tandem mass spectrometer. Three broad categories of these workflows are, targeted acquisition, information-dependent acquisition (IDA) or data-dependent acquisition (DDA), and data-independent acquisition (DIA).

In a targeted acquisition method, one or more transitions of a precursor ion to a product ion are predefined for a compound of interest. As a sample is being introduced into the tandem mass spectrometer, the one or more transitions are interrogated during each time period or cycle of a plurality of time periods or cycles. In other words, the tandem mass spectrometer selects and fragments the precursor ion of each transition and performs a targeted mass analysis for the product ion of the transition. As a result, a mass spectrum is produced for each transition. Targeted acquisition methods include, but are not limited to, multiple reaction monitoring (MRM) and selected reaction monitoring (SRM).

In an IDA method, a user can specify criteria for performing targeted or untargeted mass analysis of product ions while a sample is being introduced into the tandem mass spectrometer. For example, in an IDA method, a precursor ion or mass spectrometry (MS) survey scan is performed to generate a precursor ion peak list. The user can select criteria to filter the peak list for a subset of the precursor ions on the peak list. MS/MS is then performed on each precursor ion of the subset of precursor ions. A product ion spectrum is produced for each precursor ion. MS/MS is repeatedly performed on the precursor ions of the subset of precursor ions as the sample is being introduced into the tandem mass spectrometer.

In proteomics and many other sample types, however, the complexity and dynamic range of compounds are very large. This poses challenges for traditional targeted and IDA methods, requiring very high-speed MS/MS acquisition to deeply interrogate the sample in order to both identify and quantify a broad range of analytes. IDA methods are limited to their inherent stochastic sampling that leads to missing data points and a lack of confidence in the quantification. SRM assays have an inherent limit to the number of compounds that can be reliably quantified, and the method development time is extensive.

As a result, DIA methods, the third broad category of tandem mass spectrometry, were developed. These DIA methods have been used to increase the reproducibility and comprehensiveness of data collection from complex samples. DIA methods can also be called non-specific fragmentation methods. In a traditional DIA method (like SWATH® acquisition), the actions of the tandem mass spectrometer are not varied among MS/MS scans based on data acquired in a previous precursor or product ion scan. Instead, a precursor ion mass range is selected. A precursor ion mass selection window is then stepped across the precursor ion mass range. All precursor ions in the precursor ion mass selection window are fragmented, and all of the product ions of all of the precursor ions in the precursor ion mass selection window are mass analyzed.

The precursor ion mass selection window used to analyze the entire mass range can be varied, depending on the analyzed mass range, MS/MS accumulation time, and the required acquisition speed (cycle time). The time it takes to analyze the entire mass range once is referred to as cycle time. Generally, for LC, the cycle time is defined by the width of a chromatographic peak. Enough points (intensities as a function of elution time) must be obtained across an LC peak to determine its shape. When the cycle time is defined by the LC, the number of experiments or mass spectrometry acquisition that can be performed in one cycle defines how long each experiment or acquisition can accumulate ion observations (accumulation time).

Applying a narrow precursor ion mass selection window across a wide precursor ion mass range during each cycle, requires a short MS/MS accumulation time for each precursor window. Applying a wide precursor ion mass selection window allows the use of an increased MS/MS accumulation time for the same cycle time. Generally, better selectivity can be achieved with narrow precursor windows while better sensitivity can be achieved with wide windows using longer accumulation.

An optimized SWATH® approach considers both the effect on selectivity and the effect on sensitivity. In a SWATH® acquisition, the precursor ion mass selection window stepped across the precursor mass range in each cycle may have a width of typically 3-100 amu. In SWATH®, all the precursor ions in each precursor ion mass selection window are fragmented, and all of the product ions of all of the precursor ions in each mass selection window are mass analyzed.

U.S. Pat. No. 8,809,770, which is herein incorporated by reference in its entirety, describes how SWATH® acquisition can be used to provide quantitative and qualitative information about the precursor ions of compounds of interest. In particular, the product ions found from fragmenting precursor ions within a precursor ion mass selection window are compared to a database of known product ions of compounds of interest. In addition, ion traces or extracted ion chromatograms (XICs) of the product ions found from fragmenting precursor ions within a precursor ion mass selection window are analyzed to provide quantitative and qualitative information.

However, identifying compounds of interest in a sample analyzed using SWATH® acquisition, for example, can be difficult. It can be difficult because either there is no precursor ion information provided with a precursor ion mass selection window to help determine the precursor ion that produces each product ion, or the precursor ion information provided is from a mass spectrometry (MS) observation that has a low sensitivity. In addition, because there is little or no specific precursor ion information provided with a precursor ion mass selection window, it is also difficult to determine if a product ion is convolved with or includes contributions from multiple precursor ions within the precursor ion mass selection window.

As a result, a method of scanning the precursor ion mass selection windows in SWATH® acquisition, called scanning SWATH®, was developed. Essentially, in scanning SWATH®, a precursor ion mass selection window is scanned across a mass range so that successive windows have large areas of overlap and small areas of non-overlap. This scanning makes the resulting product ions a function of the scanned precursor ion mass selection windows. This additional information, in turn, can be used to identify the one or more precursor ions responsible for each product ion.

Scanning SWATH® has been described in International Publication No. WO 2013/171459 A2 (hereinafter “the '459 Application”). In the '459 Application, a precursor ion mass selection window is scanned with time such that the range of the precursor ion mass selection window changes with time. The timing at which product ions are detected is then correlated with the timing of the precursor ion mass selection window in which their precursor ions were transmitted.

The correlation can be done by first plotting the mass-to-charge ratio (m/z) of each product ion detected as a function of the precursor ion m/z values transmitted by the quadrupole mass filter. Since the precursor ion mass selection window is scanned over time, the precursor ion m/z values transmitted by the quadrupole mass filter can also be thought of as times. The start and end times at which a particular product ion is detected are correlated to the start and end times at which its precursor ion is transmitted from the quadrupole. As a result, the start and end times of the product ion signals are used to determine the start and end times of their corresponding precursor ions.

In one aspect, a system, method, and computer program product are disclosed for mass filtering precursor ions in a DIA method using a multipole ion guide mass filter. The system includes an ion source device, a tandem mass spectrometer, and a processor. The ion source device ionizes one or more compounds of a sample, producing an ion beam. The tandem mass spectrometer includes an ion guide chamber and a multipole ion guide disposed in the ion guide chamber. The ion guide chamber includes an inlet orifice for receiving the ions generated by the ion source device and at least one exit aperture for transmitting ions from the ion guide chamber into a vacuum chamber housing at least one fragmentation device.

The processor receives a plurality of different precursor ion mass selection windows spanning a precursor ion mass range selected for a DIA method. The processor calculates two or more different multipole ion guide precursor ion mass selection windows for transmission during the same time cycle of the tandem mass spectrometer from the plurality of different precursor ion mass selection windows.

During each cycle time of a plurality of time cycles of the tandem mass spectrometer, for each selection window of the plurality of different precursor ion mass selection windows, the processor instructs the multipole ion guide to transmit precursor ions from the ion beam within a multipole ion guide precursor ion mass selection window of the two or more different multipole ion guide precursor ion mass selection windows. The multipole ion guide precursor ion mass selection window has a width equal to or greater than the width of the selection window of a downstream mass filter configured to perform the DIA mass analysis.

In a related aspect, a mass spectrometer is disclosed, which includes a first mass filter for receiving a plurality of precursor ions and having a transmission bandwidth configured to allow transmission of ions having m/z ratios within a desired range, and a second mass filter disposed downstream of the first mass filter for selecting ions having a target m/z ratio within a transmission window thereof for mass analysis. A controller is operably coupled to the first mass filter for setting the transmission bandwidth of the first mass filter so as to encompass at least two m/z ratios such that at least one of said m/z ratios is within the transmission window of the second mass filter. The controller is configured to change the transmission bandwidth of the first mass filter over time such that any two consecutive transmission bandwidths of the first mass filter have at least one m/z ratio in common. The controller can be coupled to the second mass filter for moving the transmission window of the second mass filter for selecting a different target m/z ratio.

In some embodiments, the controller can be configured to correlate time-variation of the transmission bandwidth of the first mass filter with time variation of the transmission window of the second mass filter so as to allow mass analysis of ions having different m/z ratios transmitted through the first mass filter by the second mass filter as the transmission bandwidth of the first mass filter is shifted over time.

In some embodiments, the controller can be configured to set the ion transmission bandwidth of the first mass filter to an initial ion transmission bandwidth and to set the ion transmission window of the second mass filter so as to allow passage of ions having an m/z ratio encompassed by the initial bandwidth of the first mass filter.

In some embodiments, the controller can be configured to adjust the transmission window of the second mass filter to capture a next m/z ratio of interest and to shift the ion transmission bandwidth of the first mass filter to cover said next m/z ratio and another m/z ratio of interest.

In some embodiments, the controller can be further configured to adjust the transmission window of the second mass filter and shift the transmission bandwidth of the first mass filter substantially concurrently.

In some embodiments, the controller can be further configured to shift the ion transmission window of the second mass filter prior to adjusting the ion transmission bandwidth of the first mass filter.

In some embodiments, the controller can be configured to shift the ion transmission bandwidth of the first mass filter while the second mass filter monitors ions having an m/z ratio covered by the transmission bandwidth of the first mass filter prior to the shift thereof.

In some embodiments, the controller can be configured to set the transmission bandwidth of the first mass filter to allow transmission of ions having three or more m/z ratios.

In some embodiments, any of the transmission bandwidth of the first mass filter and the transmission window of the second mass filter can be less than about 2000 Da, e.g., in a range of about 0.1 Da to about 1500 Da, or in a range of about 1 Da to about 1000 Da, or in a range of about 10 Da to about 500 Da, or in a range of about 100 Da to about 300 Da.

In some embodiments, an ion source can be positioned upstream of the first mass filter for generating a plurality of precursor ions. The ion source can receive a sample and ionize at least a portion of the sample to generate the ions. A variety of ion sources can be employed in the practice of the present teachings.

In some embodiments, any of the first and the second mass filter includes at least one set of rods arranged in a multipole configuration to at least one of which one or more RF voltages can be applied for providing radial confinement of the ions and filter ions having certain m/z ratios, e.g., low m/z ions, and to at least one of which a DC resolving voltage can be applied for generating the transmission bandwidth thereof. In some such embodiments, the multipole configuration can be a quadrupole configuration, though other configurations, such as hexapole, can also be employed.

In some embodiments, at least one set of rods includes multiple sets of rods positioned in tandem, where each rod set comprises a plurality of rods arranged in a multipole configuration, and where optionally a DC voltage offset is applied between at least two of the rod sets so as to generate an electric field for accelerating ions passing through the first mass filter. By way of example, and without limitation, the DC voltage offset can be in a range of about 0 volt to about 200 volts.

In some embodiments, the transmission bandwidth of the first mass filter has an m/z width greater than an m/z width of the transmission window of the second mass filter.

In a related aspect, a system for performing a data-independent acquisition (DIA) method for mass spectrometry is disclosed, which includes a first mass filter for receiving a plurality of precursor ions, a second mass filter disposed downstream of the first mass filter for receiving ions exiting said first mass filter, and a controller that is operably coupled to the first mass filter and the second mass filter to configure the second mass filter to provide a plurality of ion selection windows over a DIA mass analysis cycle such that the mass selection windows collectively span a precursor ion mass range associated with the DIA analysis. The controller may configure the first mass filter to provide a plurality of ion transmission bandwidths such that each of the ion transmission bandwidths is configured to prefilter the precursor ions for at least one respective one of the ion selection windows of the second mass filter such that each of the ion transmission bandwidths of the first mass filter has an m/z width greater than an m/z width of a respective ion selection window of the second mass filter.

In some embodiments, at least one of the ion transmission bandwidths of the first mass filter has a lower low m/z cutoff and a higher high m/z cutoff than a respective low m/z cutoff and high m/z cutoff of said at least one respective ion selection window of the second mass filter. In some such embodiments, the at least one respective ion selection window of the second mass filter includes at least two consecutive ion selection windows.

In some embodiments, at least two of the ion transmission bandwidths of the first mass filter can have at least one m/z ratio in common.

In some embodiments, at least two of the plurality of the ion transmission bandwidths of the first mass filter have different m/z widths.

In some embodiments, the system can further include a fragmentation device that is disposed downstream of the second mass filter for receiving the precursor ions exiting the second mass filter and causing fragmentation of at least a portion thereof to generate a plurality of product ions. Further, a mass analyzer can be positioned downstream of the fragmentation device for receiving the product ions and generating a mass spectrum thereof.

In some embodiments, each of the first and the second mass filter can be positioned in an evacuated chamber. The second evacuated chamber can be maintained at a pressure lower than a pressure at which the first evacuated chamber is maintained.

In some embodiments, each of the mass filters can be implemented via a multipole rod set positioned in a respective evacuated chamber. In some such embodiments, RF and DC voltage sources can be employed to apply RF voltages to the rods for providing radial confinement of the ions and a DC resolving voltage can be applied across at least two of the rods of the multipole rod set to generate a desired ion transmission bandwidth/window in a manner known in the art. The controller can be operably coupled to the RF and the DC voltage sources for adjusting the RF and DC voltages so as to generate the desired transmission bandwidth/window of the first and the second mass filters.

In some embodiments, the first multipole rod set can include a plurality of rod segments, where each rod segment is spaced from an adjacent rod segment and extends along a central longitudinal axis of the multipole rod set. In some embodiments, the plurality of rod segments includes a first rod segment, a second rod segment positioned downstream of the first rod segment and a third rod segment positioned downstream of the second rod segment. In some such embodiments, the first rod segment is configured to receive ions from an upstream ion source and to cause cooling of the received ions and the second rod segment is configured to filter the cooled ions received from the first rod segment. Further, the third rod segment is configured to transmit ions received via the second rod segment out of the mass filter.

The mass filter can further include a plurality of auxiliary electrodes disposed between a plurality of rods of the multiple rod set, where RF voltages applied to the rods of the multipole rod set provide a low m/z cutoff and a DC voltage differential applied between said multipole rod set and said auxiliary electrode provides a high m/z cutoff.

In a related aspect, a system for performing a data-independent acquisition (DIA) mass analysis in a tandem mass spectrometer is disclosed, which includes a mass filter for receiving a plurality of precursor ions, where the mass filter is positioned in a low vacuum (region of the mass spectrometer that is maintained at a pressure greater than about 5e⁻⁵ Torr, e.g., at a pressure in a range of about 10⁻³ Torr to about 10⁻² Torr). A controller is operably coupled to the mass filter and is configured to control the mass filter such that the mass filter provides a plurality of ion selection windows over a DIA mass analysis cycle, where the ion selection windows collectively span a precursor ion mass range associated with said DIA mass analysis. An ion fragmentation device is positioned downstream of the mass filter for receiving precursor ions transmitted through the mass filter and causing fragmentation of at least a portion of the received precursor ions to generate a plurality of product ions. No other mass filter functionality is provided between the mass filter and the ion fragmentation device. For example, in some embodiments, no other mass filter is positioned between the mass filter and the ion fragmentation device. In other embodiments, although one or more additional mass filters may be positioned between the mass filter and the ion fragmentation device, such mass filters are not maintained in a functional mode during operation of the system.

In some embodiments, at least two of the ion selection windows can be overlapping. Further, in some embodiments, at least two of the ion selection windows can have different m/z widths. Moreover, in some embodiments, at least two of the ion selection windows can be overlapping and further have different m/z widths.

In some embodiments, the mass filter can include a multipole rod set that is configured for application of RF and/or DC voltages thereto for generating the ion selection windows. By way of example, the multipole rod set can include a quadrupole rod set, a hexapole rod set, among others. At least one RF voltage source and at least one DC voltage source can be utilized to generate the RF and/or DC voltages for application to the multipole rod set. A controller can be operably coupled to the RF and DC voltage sources for controlling thereof so as to adjust the RF and/or DC voltages for generating the ion selection windows.

In some embodiments, the mass filter and the fragmentation device can be positioned in two different evacuated chambers, where the chamber in which the fragmentation device is positioned is maintained at a different pressure than the chamber in which the mass filter is positioned.

In a related aspect, a mass spectrometer is disclosed, which comprises a first mass filter for receiving a plurality of ions and having a transmission bandwidth (a bandpass window) configured to allow transmission of ions having m/z ratios within a desired range, and a second mass filter (which can be configured as a mass analyzer) disposed downstream of the first mass filter for selecting ions having a target m/z value within a transmission window thereof for mass analysis, where the bandpass window of the first mass filter covers at least two m/z ratios of interest such that one of the m/z ratios corresponds to the target m/z value within the transmission window of the second mass filter.

In some embodiments, a controller is coupled to the first mass filter for shifting the bandpass window thereof over time so as to include different m/z ratios of interest. The controller is coupled to the second mass filter (which in many embodiments is configured as a mass analyzer) for moving the transmission window of the mass filter for selecting a different target m/z value. The controller can be configured to correlate the time-variation of the bandpass window of the first mass filter with the time variation of the transmission window of the second mass filter so as to allow mass analysis of ions having different m/z ratios transmitted through the first mass filter by the second mass filter (mass analyzer) as the bandpass window of the first mass filter is shifted over time.

By way of example, the controller can be configured to set the bandpass window of the first mass filter to an initial value and to set a transmission window of the second mass filter (mass analyzer) so as to allow passage of one of the ions covered by the initial bandpass window of the first mass filter. The controller can also be configured to adjust the transmission window of the second mass filter (mass analyzer) to cover the next m/z ratio of interest and shift the bandpass window of the first mass filter to cover said next m/z ratio and at least another m/z ratio of interest. In some embodiments, the controller can select the m/z ratios of interest from a list of m/z ratios that were previously provided to the controller.

In some embodiments, the controller can be configured to shift the bandpass window of the first mass filter and that of the second filter (mass analyzer) substantially concurrently. For example, in some such embodiments, the controller can be configured to shift the bandpass window of the first mass filter while the second mass filter is monitoring ions with an m/z ratio covered by the bandpass window of the first mass filter prior to the shift.

In general, the bandpass window of the first mass filter can be selected to allow passage of multiple m/z ratios while ensuring that it continues to inhibit the passage of unwanted ions. By way of example, in some embodiments, the bandpass window of the first mass filter can be in a range of about 30 Da to about 200 Da. Further, in some such embodiments, the bandpass window of the second mass filter (mass analyzer) can be selected to allow passage of an m/z ratio of interest while inhibiting the passage of unwanted ions. By way of example, in some embodiments, the bandpass window of the second mass filter (mass analyzer) can be in a range of about 0.3 Da to about 100 Da, e.g., in a range of about 10 Da to about 50 Da.

In some embodiments, the first mass filter can include a set of rods arranged in a quadrupole configuration to which RF and DC voltages can be applied for providing radial confinement of the ions and a desired bandpass window for ion transmission. In some such embodiments, the first mass filter can include a plurality of rod segments, each of which is arranged in a quadrupole configuration. In some such embodiments, RF voltages are applied to certain of the rod sets, e.g., the rod sets positioned proximate to the inlet and the outlet of the first mass filter, while RF as well as DC resolving voltages are applied to at least one of the rod sets positioned between the rod sets to which RF voltages are applied. Further, in some such embodiments, at least one DC offset voltage can be applied between at least two consecutive rod sets to provide an axial electric field that can facilitate the transit of the ions through the mass filter. In some such embodiments, the DC offset voltages are selected so as to ensure that ions continue to move through the mass filter while maintaining a low axial kinetic energy as they exit the mass filter. By way of example, in some embodiments, the DC offset voltage can be in a range of about 0 V to about 20 V. In some embodiments in which collisional fragmentation of ions within the first mass filter may be desired, higher DC offset voltages may be employed, e.g., as high as 200 V may be employed.

In some embodiments, a collision cell can be disposed downstream of the second mass filter for receiving ions passing through the second mass filter and causing fragmentation of at least a portion of those ions so as to produce a plurality of product ions. A mass analyzer can be positioned downstream of the collision cell to receive at least a portion of the product ions and provide a mass analysis thereof. An ion detector can be positioned downstream of such a mass analyzer for detecting the ions passing through the mass analyzer and generating detection signals in response to the detection of those ions. An analyzer in communication with the ion detector can receive the detection signals generated by the detector and process those detection signals to generate a mass spectrum of the product ions.

In some embodiments, the mass spectrometer can be a time-of-flight (ToF) mass spectrometer. Further, in some embodiments, the mass spectrometer is configured to operate in a data independent acquisition (DIA) mode, such as in SWATH® data acquisition mode. In some embodiments the mass spectrometer can be a tandem mass spectrometer (such as a triple quadrupole mass spectrometer) or any other MS system known in the art. For some experiments the MS is operated in an MRM mode to monitor successive parent ions in Q1 and the corresponding daughter ions in Q3.

In some embodiments, the system can further include an ion source that is positioned upstream of the first mass filter to ionize a sample under investigation to generate a plurality of ions. A variety of ion sources, such as those listed below, can be employed in the practice of the present teachings.

Further understanding of various aspects of the present teachings can be obtained by reference to the following detailed description and the associated drawings, which are described briefly below.

### BRIEF DESCRIPTION OF THE DRAWINGS

FIG. 1 is a schematic example of a bandpass window of a conventional mass filter providing a plurality of bandpass windows each of which encompasses an m/z ratio;

FIG. 2 is a flow chart depicting various steps in an embodiment of a method according to the present teachings for performing mass spectrometry;

FIG. 3 schematically shows a mass filter according to the present teachings;

FIG. 4A shows a schematic example of a bandpass window of a mass filter according to the present teachings, where the bandpass window covers two or three m/z ratios at a time, for transmission;

FIG. 4B shows a schematic example of a bandpass window of a mass filter according to the present teachings, where the bandpass window covers two m/z ratios at a time, for transmission;

FIG. 5 schematically shows a quadrupole rod set viewed in the axial direction;

FIG. 6 schematically depicts a cross-sectional view of a multipole ion guide that can be configured as a mass filter for use in some embodiments of the present teachings;

FIG. 7 depicts another schematic view of the multipole ion guide shown in FIG. 6;

FIG. 8 schematically shows a mass spectrometer according to an embodiment of the present teachings;

FIGS. 9A, 9B, and 9C show examples of bandpass windows that were obtained for a four-segment mass filter, such as that schematically depicted in FIG. 3, via application of suitable RF and resolving DC voltages to various rods of the mass filter;

FIG. 10A shows the transit time from the lens IQ0 to the detector as a function of ion mass for the following DC settings of the QJet® ion guide and various segments of the ion guide Q0;

FIG. 10B shows a time segment of the data presented in FIG. 10A extending from t=0 to t=3 milliseconds;

FIG. 11 schematically shows an example of a controller that can be implemented in the mass spectrometer according to the present teachings;

FIG. 12 shows a timing diagram illustrating one example of operating a mass filter and downstream mass analyzer according to an embodiment of the present teachings;

FIG. 13 shows another timing diagram of operating a mass filter and a downstream mass analyzer according to an embodiment of the present teachings;

FIG. 14 is an exemplary diagram showing how different precursor ion mass selection windows that span a mass range are scanned in a conventional DIA method, upon which various embodiments may be implemented;

FIG. 15 is an exemplary diagram showing how a multipole Q0 ion guide can perform mass filtering by using different Q0 precursor ion mass selection windows, in accordance with various embodiments;

FIG. 16 is an exemplary diagram showing how a Q0 ion guide can perform mass prefiltering by using Q0 precursor ion mass selection windows to prefilter Q1 precursor ion mass selection windows, in accordance with various embodiments;

FIG. 17 is an exemplary diagram showing how a Q0 ion guide can perform mass prefiltering using one Q0 precursor ion mass selection window to prefilter two different Q1 precursor ion mass selection windows, in accordance with various embodiments;

FIG. 18 is an exemplary diagram of a Q0 multipole ion guide with segmented rods that can be used for mass filtering or prefiltering, in accordance with various embodiments;

FIG. 19 is an exemplary diagram showing the Q0 multipole ion guide of U.S. Published Application No. 2018/0096832 (hereinafter the “'832 Application”) and International Publication No. WO 2020/039371 (hereinafter the “'371 Application”), upon which various embodiments may be implemented;

FIG. 20 is an exemplary perspective view of the auxiliary electrodes of the '832 Application and the '371 Application, upon which various embodiments may be implemented;

FIG. 21 is an exemplary cross-sectional view of the Q0 multipole ion guide of the '371 Application, upon which various embodiments may be implemented;

FIG. 22 is an exemplary plot showing how different RF voltages applied to quadrupole rods produce different precursor ion mass selection window widths with different DC voltages applied to the T-bar electrodes interposed between the quadrupole rods of a Q0 multipole ion guide, in accordance with various embodiments;

FIG. 23 is an exemplary plot of the same data shown in FIG. 23 showing the different center mass locations and widths that can be produced using a Q0 multipole ion guide that includes quadrupole rods and T-bars interposed between them, in accordance with various embodiments;

FIG. 24 is an exemplary table showing different RF quadrupole rod voltages and DC T-bar voltages applied to quadrupole rods and T-bars, respectively, of a Q0 multipole ion guide to produce a 150 Da Q0 precursor ion mass selection window, in accordance with various embodiments;

FIG. 25 is an exemplary plot showing how the DC voltage applied to auxiliary electrodes of a Q0 multipole ion guide varies with the RF voltage applied to the multipole rod set of the Q0 multipole ion guide in order to maintain a constant Q0 precursor ion mass selection window width, in accordance with various embodiments;

FIG. 26 is an exemplary flowchart showing a method for synchronizing Q0 precursor ion mass selection windows with Q1 precursor ion mass selection windows, in accordance with various embodiments;

FIG. 27 is a schematic diagram showing a system for mass filtering precursor ions in a DIA method using a multipole ion guide mass filter, in accordance with various embodiments;

FIG. 28 is a flowchart showing a method for mass filtering precursor ions in a DIA method using a multipole ion guide mass filter, in accordance with various embodiments;

FIG. 29 is a block diagram that illustrates a computer system, upon which embodiments of the present teachings may be implemented; and

FIG. 30 is a schematic diagram of a system that includes one or more distinct software modules that perform a method for mass filtering precursor ions in a DIA method using a multipole ion guide mass filter, in accordance with various embodiments.

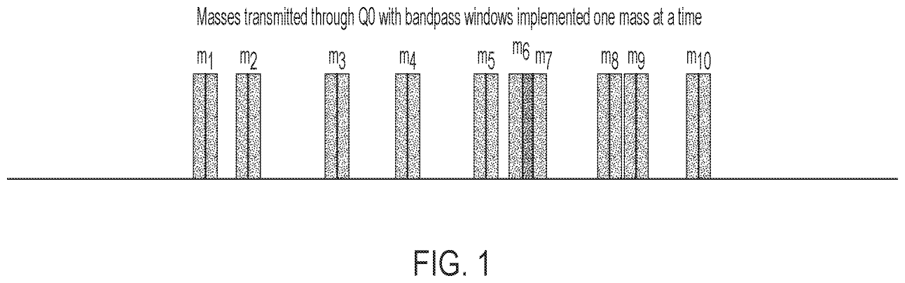

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed an any great detail. One of ordinary skill will recognize that some embodiments of the present disclosure may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

The present teachings relate to systems and methods for performing mass spectrometry, and particularly to such methods and systems that employ at least one mass filter that is disposed upstream of a mass analyzer, where the mass filter is configured to have a bandpass window encompassing multiple m/z ratios such that at least one of those m/z ratios corresponds to an m/z ratio within the bandpass window of the downstream mass analyzer. Without any loss of generality and for illustrating various aspects of the present teachings, the embodiments described below include a mass filter and a downstream mass analyzer that are placed in tandem. It should, however, be understood that the present teachings are not limited to mass spectrometric systems having only a mass filter and a downstream mass analyzer.

Unlike conventional systems, in a system according to the present teachings, the upstream mass filter can have a bandpass window in the mass-to-charge (m/z) ratio domain that covers multiple m/z ratios, which are transferred to the downstream mass analyzer. In many embodiments, the bandpass window of the downstream mass analyzer is configured to allow passage of one m/z ratio at a time. In other embodiments, the downstream mass analyzer has a bandpass window that covers multiple m/z ratios. By configuring the bandpass window of the upstream mass filter to allow ions across multiple m/z ratios to be transmitted, a more rapid analysis of a plurality of ions with different m/z ratios can be achieved, as discussed in more detail below. In the following discussion, in some cases, the first mass filter is referred to as a first mass analyzer and the second mass filter is referred to as a second mass analyzer.

Various terms are used herein in accordance with their ordinary meanings in the art. The terms “bandpass window,” “transmission bandwidth,” “transmission window,” and “bandwidth” are used herein interchangeably to refer to a range of m/z ratios that can be transmitted through a mass filter or a mass analyzer while the passage of ions with m/z ratios outside of that range is substantially reduced, or preferably, inhibited.

The term “Q0” refers to a component of a tandem mass spectrometer that first receives ions from an ion beam in the collision-cooling region. Also, note that the term “Q1” refers to a component of a tandem mass spectrometer that first receives ions from a Q0 component and is located in a vacuum chamber that has a lower pressure than the vacuum chamber that includes the Q0 component. Depending on its functionality and/or configuration, “Q0” may be referred to as a mass filter, a first mass filter, a prefilter, an ion guide, a multipole ion guide, or a quadrupole ion guide. Depending on its functionality and/or configuration, “Q1” may be referred to as a mass analyzer, a mass filter, a mass filter device, a second mass filter, a quadrupole, or quadrupole rods.

A “low pressure region of a mass spectrometer” refers to a region (e.g., various evacuated chambers) of a mass spectrometer (e.g., a chamber in which the Q1 mass analyzer is positioned) that is maintained at a pressure below about 5×10⁻⁵ Torr. An “intermediate pressure region” of the mass spectrometer refers to a region of the mass spectrometer (e.g., a chamber in which the Q0 mass analyzer is positioned) that is maintained at a pressure about 10-50 times higher than the pressure of the low pressure region. In some cases, the mass spectrometer can include a high pressure region, e.g., a region maintained at a pressure of about 2-10 Torr.

Although examples of embodiments described herein can include a plurality of modules for implementing aspects of present teachings, it is understood that various aspects of the exemplary processes according to the present teachings may also be performed by one or plurality of modules. Additionally, it is understood that the term controller/control unit refers to a module that can be implemented in hardware/firmware/software or combination thereof. In some embodiments, the controller can include a processor, memory and one or more communication buses for providing communication among its various components. For example, instructions for performing various methods disclosed herein, such as analysis of ion detection signals for generating a mass spectrum, can be stored in one or more memory modules and can be used during runtime by the processor to implement the method.

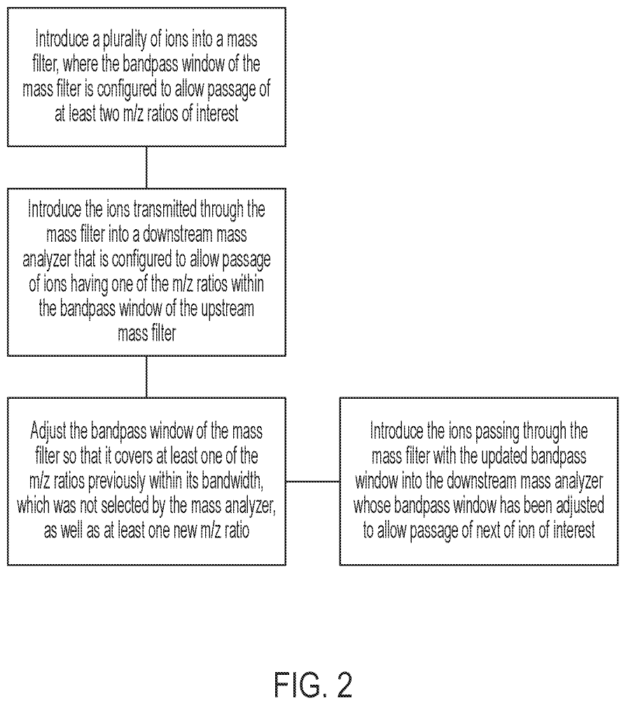

With reference to the flow chart of FIG. 2, a method according to an embodiment of the present teachings for performing mass spectrometry includes introducing a plurality of ions into a mass filter having a bandpass window that allows transmission of at least two ions of interest having different m/z ratios. This is followed by introducing the ions transmitted through the mass filter into a downstream mass analyzer that is configured to allow passage of ions having one of the m/z ratios within the bandpass window of the upstream mass filter. In some embodiments, the downstream mass analyzer allows passage of ions with multiple m/z ratios.

Subsequently, the bandpass window of the mass filter can be adjusted such that it would encompass at least one of m/z ratios that was previously within its bandwidth, and which was selected by the downstream mass analyzer, for transmission as well as at least a new m/z ratio.

The ions are then transmitted through the mass filter with the updated bandpass window to the downstream mass analyzer. The downstream mass analyzer is in turn adjusted to select the ion having the m/z ratio that is common between the previous and the adjusted bandwidths of the mass filter (i.e., the ions that could be transmitted through the mass filter in its original and updated configuration). When operating in a SWATH® acquisition mode, the downstream mass analyzer is adjusted to select a range of ions with different m/z ratios. By way of example, in some cases, in a TOF MS/MS system, the downstream mass analyzer can be operated in a low resolution mode such that an isotopic cluster of ions or a range of m/z values is transmitted through the mass analyzer.

Again, in some embodiments, at least some of the ions selected by the mass analyzer can be fragmented to generate a plurality of product ions, which can in turn be subjected to mass analysis. As discussed in more detail below, the adjustment of the bandpass window of the mass filter and that of the downstream mass analyzer can be done substantially concurrently. Alternatively, the bandpass window of the mass filter can be shifted (updated) prior to updating the bandpass window of the downstream mass analyzer. Further, as discussed in more detail below, in some embodiments, ion fragmentation can occur in one or more segments of the mass filter that are disposed upstream of the segment that is configured to have a bandpass window that is configured in accordance with the present teachings to encompass two or more m/z ratios associated with the fragment ions.

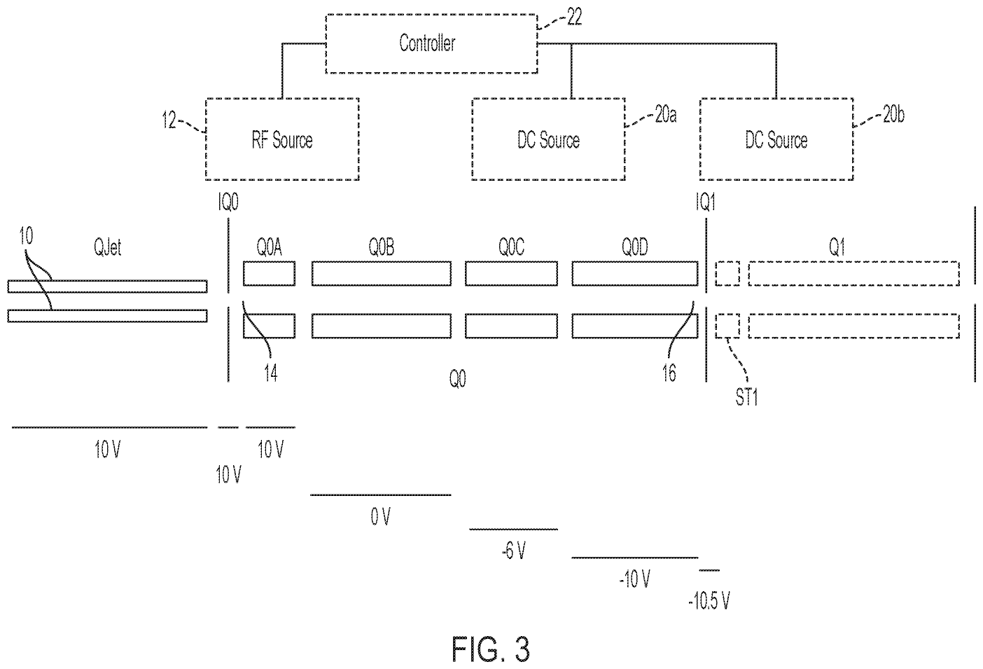

The above method can be utilized to perform multiple-reaction monitoring mass spectrometry (MRM). For example, with reference to FIG. 3, in one example of an implementation of such an embodiment, an ion guide QJet® can receive ions from an upstream ion source (not shown in FIG. 3) and focus the received ions into an ion beam that is transmitted into a mass filter Q0. The ion guide QJet® includes four rods 10 (two of which are visible in FIG. 3) that are arranged according to a quadrupole configuration. An RF source 12 applies RF voltages to the four rods 10 in a manner known in the art to provide radial focusing of the ions passing through the ion guide QJet®. An ion lens IQ0 is disposed between the ion guide QJet® and the mass filter Q0 to allow differential pumping of the QJet® and Q0 chambers and can provide enhanced transmission and focusing of the ions.

In this embodiment, the mass filter Q0 includes four sets of rods Q0A, Q0B, Q0C, and Q0D, which are positioned in series relative to one another in a quadrupole configuration to provide a passageway through which ions received via an inlet 14 of the mass filter Q0 can propagate to its outlet 16 through which the ions exit the mass filter Q0. In this embodiment, the RF voltage source 12 (or a separate RF voltage source) and a DC voltage source 20a apply RF and DC voltages to the rods of the mass filter Q0 so as to provide radial focusing of the ions as well as establish a bandpass window (i.e., a transmission window) for passage of ions through the mass filter Q0.

In other words, ions having m/z ratios that fall within the bandpass window of the mass filter Q0 can pass through the mass filter Q0 while transmission of ions having m/z ratios that fall outside the bandpass window is substantially reduced, and preferably inhibited. As discussed in more detail below, in this embodiment, RF voltages (signals) are applied to the first, second, and fourth sets of rods Q0A, Q0B, and Q0D, while an RF voltage as well as a resolving DC voltage (for setting the bandpass window of the mass filter Q0) are applied to the third set of rods QC, as discussed in more detail below. Further, in this embodiment, the rods of QUA and Q0B rod sets are tilted relative to the longitudinal axis of the mass filter Q0 so as to provide an upstream effective potential that is greater than a downstream effective potential, thereby producing an off-axis axial gradient pointing downstream along the length of the rods of Q0A and Q0B rod sets. In addition, in this embodiment, the rod sets Q0A and Q0B have a smaller field radius than Q0C rod set. Further, the RF voltages applied to the QUA and Q0B rod sets have a lower amplitude than the amplitude of the RF voltages applied to Q0C rod set because in this embodiment the RF voltages applied to Q0A and Q0B rod sets are obtained, via capacitive coupling, from the RF voltage supply that applies RF voltages to the QC rod set. Consequently, the ions at the exit of the Q0B rod set exhibit a higher value for the Mathieu q parameter than those at the entrance to the Q0C segment. The higher q value at the exit of the Q0B rod set results in a higher effective potential at the exit of the Q0B rod set than at the entrance of the Q0C rod set, thereby reducing ion reflections at the Q0B/Q0C boundary.

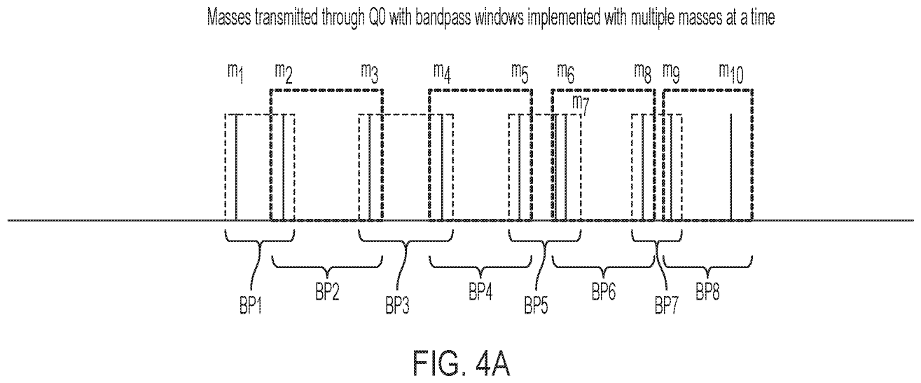

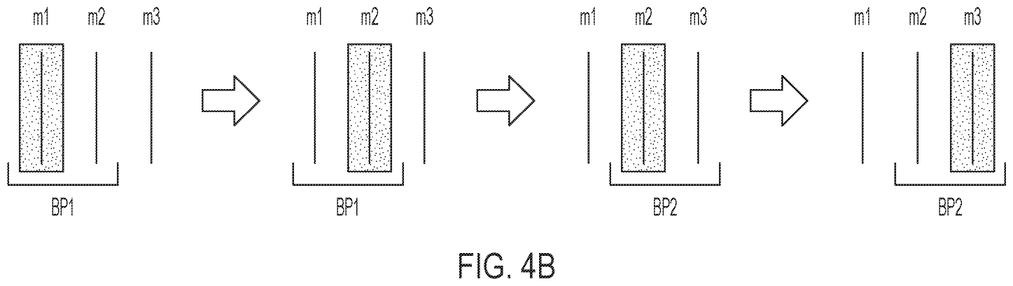

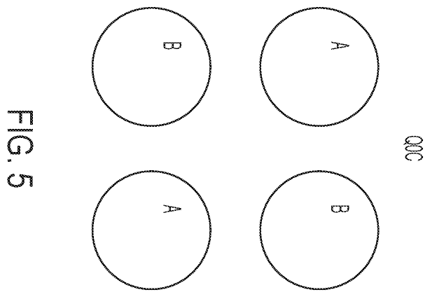

In some such embodiments, the bandpass window of the mass filter Q0 (e.g., a quadrupole mass filter) can be configured to include the mass of a precursor ion of interest plus the mass of the next precursor to be monitored. This is shown schematically in FIGS. 4A and 4B. In this example, initially, the mass filter Q0 is configured to have a bandpass window (BP1) that allows transmission of ions with m/z ratios of m₁ and m₂, and the mass analyzer Q1 is configured to allow transmission of ions with m/z ratio of m₁. When the transmission window of the mass analyzer Q1 is shifted to the next mass of interest, i.e., ions with m/z ratio of m₂, the bandpass window of the mass filter Q0 is adjusted to allow transmission of ions with m/z ratio of m₂ as well as ions with m/z ratio of m₃ (this adjusted bandpass window is designated herein as BP2).

In many embodiments, such adjustment of the bandpass window of the mass filter Q0 can be accomplished by first adjusting at least one operational parameter (e.g., the RF voltage or the DC resolving voltage) to create a wider bandpass window followed by adjusting at least another operational parameter to narrow the mass filter's bandpass window to a desired width. For example, the DC resolving voltage and the amplitude of the applied RF voltage can be used to adjust the bandpass window of the mass filter.

In some embodiments, the order in which the RF voltage and the DC resolving voltage are changed can depend upon the required RF and DC resolving voltages for a subsequent bandpass window. For example, if the subsequent bandpass window were to remain at the same size but shifted toward a lower mass, then the resolving DC voltage would need to be decreased before the RF amplitude is decreased. (See, e.g., the transition from BP5 to BP6 in Table 1 below). If a desired width of a subsequent bandpass window is less than the present bandpass window, then RF voltage can be increased first to create a wider bandpass window before increasing the DC resolving voltage to narrow the bandpass window to the desired width (See, e.g., the transition from BP3 to BP4 in Table 1 below). If the bandpass were moving towards a lower pair of masses, such as transitioning from BP4 to BP3, the width of the bandpass window is narrowed by a decrease in the RF voltage amplitude followed by a decrease in the DC resolving voltage.

By way of further illustration, Table 1 below provides examples of RF voltages as well as DC resolving voltages for adjusting the bandpass of a mass filter according to the present teachings. This example shows that the bandpass resolving DC voltage can decrease even though the bandpass window has moved to higher mass if the width of the bandpass window increases. An example of accomplishing such a change in the bandpass window can be seen in Table 1 below by comparing the row BP3 to the row BP4 of the table. In this example, a bandpass window from 265 to 295 requires 52.4 V of resolving DC voltage while the bandpass window from 275 to 385 requires less resolving DC voltage, 46.8 V.

TABLE 1

| | | m/z | BP | BP | RF Vpp | |
|---|---|---|---|---|---|---|
| | Width | ratios | lower | upper | Pole to | Resolving |
| Bandpass | (Da) | in BP | edge | edge | Ground | DC (V) |
| BP1 | 30 | 210/230 | 205 | 235 | 527.1 | 39.8 |
| BP2 | 50 | 230/270 | 225 | 275 | 584.5 | 41.9 |
| BP3 | 30 | 270/280 | 265 | 295 | 678.1 | 52.4 |
| BP4 | 110 | 280/380 | 275 | 385 | 729.2 | 46.8 |
| BP5 | 50 | 380/420 | 375 | 425 | 962.5 | 73.3 |
| BP6 | 50 | 380/340 | 335 | 385 | 844.0 | 70.2 |

By way of example, with reference to FIG. 4B, initially, the bandpass window of the mass filter Q0 can be increased to cover both m₂ and m₃, without disrupting the flow of m₂ ions into the downstream mass analyzer Q1. Following the change in the RF voltage of the mass filter Q0, the DC resolving voltage applied to the mass filter Q0 is adjusted so as to tailor its bandpass window to a desired width. In many such embodiments, the mass analyzer Q1 is operated to select ions with m/z ratio of m₃ while the DC resolving voltage applied to the mass filter Q0 is being adjusted. Subsequently, with reference to FIG. 4A, the bandpass window of the mass filter Q0 can be adjusted to cover m/z ratios of m₃ and m₄ (i.e., bandpass window designated as BP3). In this example, this is followed by adjusting the bandpass window of the mass filter Q0 to cover ma and m₅ (See, bandpass window designated as BP4).

In this embodiment, the RF and the DC voltage sources 12, 20a, and 20b are operated under the control of a controller 22 to control the application of RF and DC voltages to the mass filter Q0 as well as the mass analyzer Q1 so as to set and adjust the bandpass window of the mass filter Q0 and the transmission window of the mass analyzer Q1. More specifically, the controller 22 can be programmed to control the RF and the DC voltage sources such that the RF and DC voltages that are applied to the rods of the mass filter Q0 and the mass analyzer Q1 provide a desired bandpass window for the mass filter Q0 and also allow transmission of ions having a desired m/z ratio through the downstream mass analyzer Q1. Further, the controller 22 can update the bandwidth window of the mass filter Q0 to the next bandpass window and also adjust the RF and/or DC voltages applied to the mass analyzer Q1 to switch the transmission of ions through the mass analyzer Q1 from one m/z ratio to another.

For example, at the beginning of a measurement cycle, the controller 22 can set the bandpass window of the mass filter Q0 and the transmission window of the mass analyzer Q1 such that the bandpass window of the mass filter Q0 would cover multiple m/z ratios of interest and the transmission window of the mass analyzer Q1 would cover one of those m/z ratios. After a preset period of time (e.g., the time required for the mass analyzer Q1 to process the ions having the m/z ratios of interest), the controller 22 switches the transmission window of the mass analyzer Q1 to the next m/z ratio of interest, which is already within the bandwidth window of the mass filter Q0, and also shifts the bandwidth window of the mass filter Q0 to cover, in addition to the m/z ratio that is being processed by the mass analyzer Q1, a new m/z ratio of interest, e.g., based on a predefined list of m/z ratios of interest that was previously provided to the controller.

In some embodiments, the controller 22 can be configured to shift the transmission bandwidth of the mass filter Q0 and the transmission window of the mass analyzer Q1 substantially concurrently. In other embodiments, the controller 22 can be configured to shift the transmission bandwidth of the mass filter Q0 before shifting the transmission window of the mass analyzer Q1 to the next m/z of interest. For example, referring again to FIG. 4B, while the mass analyzer Q1 is monitoring ions with an m/z of m₂, the controller 22 can shift the transmission bandwidth of the mass filter Q0 to cover ions with m/z ratios of m₂ and m₃ (i.e., from BP1 to BP2). The controller 22 can then shift the transmission window of the mass analyzer Q1 to cover the m/z ratio of m₃ while ions with an m/z ratio of m₃ are equilibrating, e.g. via collisional cooling, in the mass filter Q0.

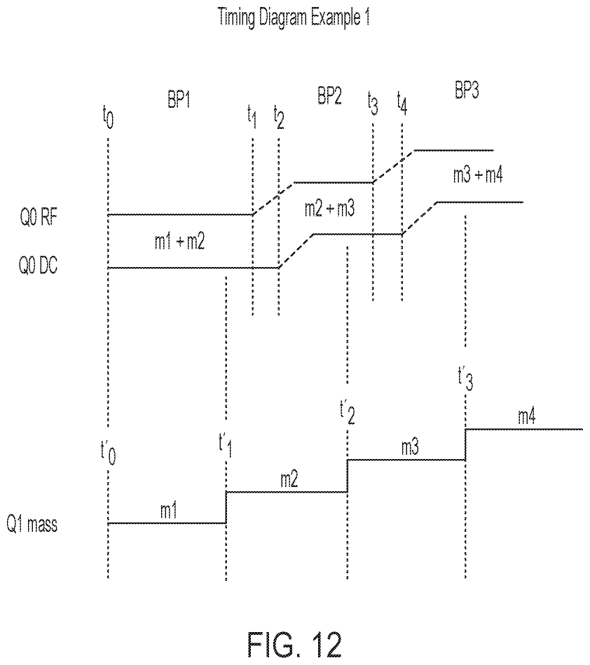

By way of illustration, FIG. 12 shows a timing diagram indicating one example of operating the mass filter Q0 and the mass analyzer Q1 in accordance with an embodiment of the present teachings. In this example, the Q1 mass analyzer is configured to measure m₁ while the RF voltage and DC resolving voltages applied to the mass filter Q0 are set such that the bandpass window of the mass filter Q0 would encompass m₁ and m₂ masses. At time t′₁, the bandpass window of the mass analyzer Q1 is adjusted to monitor m₂ and at time t₁ the RF voltage is increased followed by an increase in the DC resolving voltage at a subsequent time t₂ so as to change the bandpass window of the mass filter Q0 to cover masses m₂ and m₃ while the mass analyzer Q1 continues to monitor m₂. At time t′₂, the mass analyzer Q1 is switched to monitor m₃ while the bandpass window of the Q0 mass filter continues to cover m₂ and m₃. At time t₃, the RF voltage is increased followed by an increase in the DC resolving voltage at a subsequent time ta so as to change the bandpass window of the mass filter Q0 to cover m₃ and m₄ while the mass analyzer Q1 continues to monitor m₃. Subsequently, the mass analyzer Q1 is switched to monitor m₄. In this example, the controller changes the RF voltage of the mass filter Q0 before changing the DC resolving voltage of the mass filter Q0, which is represented by the timing for bandpass windows changing from BP1 to BP2 to BP3 (See, Table 1 above).

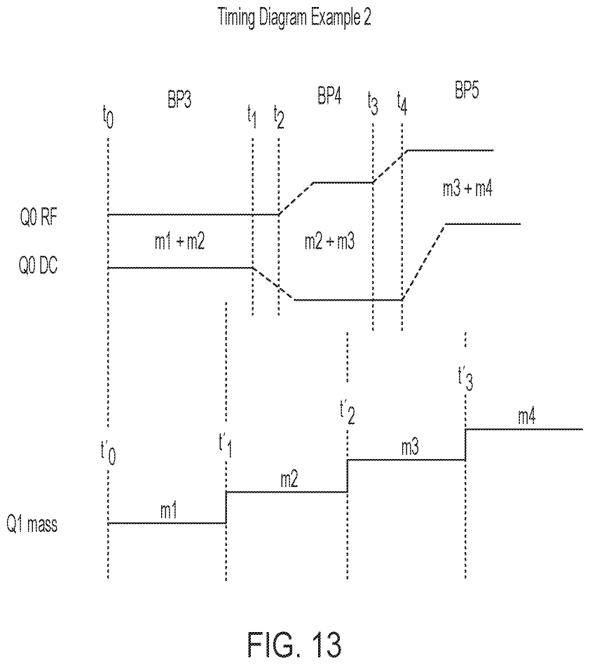

By way of further illustration, FIG. 13 shows another timing diagram for operating the mass filter Q0 and the mass analyzer Q1. The mass analyzer Q1 is set to monitor m₁ while the bandpass window of the mass filter Q0 encompasses m₁ and m₂. The mass analyzer Q1 switches to m₂ at time t′₁ while the bandpass window of the mass filter Q0 still encompasses m₁ and m₂, and the mass analyzer Q1 continues to monitor m₂. At time t₁, the DC resolving voltage applied to the mass filter Q0 is reduced so as to change the bandpass window of the mass filter Q0 to encompass m₂ and m₃, and at time to the RF voltage applied to the mass filter Q0 is increased to narrow the bandpass window while the mass analyzer Q1 is still monitoring m₂. Subsequently, at time t′₂, the mass analyzer Q1 switches to monitoring m₃, and at a subsequent time t₃, the RF voltage applied to the mass filter Q0 is increased to change the bandpass window of the mass filter Q0 to encompass m₃ and ma followed by increasing the DC resolving voltage applied to the mass filter Q0 at time t₄. Subsequently, at time t′₃, the mass analyzer Q1 switches to monitoring m₄. In this example, the DC resolving voltage applied to the mass filter Q0 changes before the application of the RF voltage to the mass filter Q0, represented by the timing for bandpass windows changing from BP3 to BP4 to BP5 (See, Table 1).

It is noted that all ions having masses greater than the low mass cut-off of the mass filter Q0 segments that are positioned upstream of the segment in which the bandpass window is created are present in those upstream segments.

While in some embodiments the controller 22 shifts the bandpass window of the mass filter Q0 and the bandpass window of the mass analyzer Q1 in the direction of increasing m/z ratios, in other embodiments the controller 22 can be configured to shift the bandpass window of the mass filter Q0 and the bandpass window of the mass analyzer Q1 in the direction of decreasing m/z ratios.

In some cases, the bandpass window of the mass filter Q0 can encompass more than two m/z ratios. For example, as shown in FIG. 4A, the bandpass window BP5, which follows the bandpass window BP4, covers three m/z ratios, namely, m₅, m₆ and m₇.

Further, the bandpass window of the mass filter Q0 can be configured to allow passage of ions having any desired m/z ratios. In some embodiments, the choice of the bandpass window of the mass filter Q0 can be informed by the number of unwanted ions that may be contained within the bandpass window that could lead to contamination. The unwanted ions are those that mass analyzer Q1 will not select for transmission to downstream components, e.g., as precursor ions for subsequent fragmentation in a collision cell for monitoring MRM transitions.

As noted above and shown in FIG. 3, in this embodiment, the mass filter Q0 includes four sets of rods Q0A, Q0B, Q0C, and Q0D that are placed in series relative to one another. In this embodiment, each of the four sets Q0A, Q0B, Q0C, and Q0D includes four rods that are arranged in a quadrupole configuration. The segment of the mass filter Q0 that is configured to provide a bandpass window according to the present teachings is implemented as a quadrupole; however, other segments of the mass filter Q0 can be implemented using other multipole configurations, such as hexapole, octupole, etc.

Referring to FIG. 5, for each of the four rod sets Q0A, Q0B, QC, and Q0D, the rods marked ‘A’ are electrically connected, and are referred to as the A-pole. The rods marked ‘B’ are electrically connected and are referred to as the B-pole.

RF signals are applied to the first and the fourth sets of rods Q0A and Q0D. Further, in this embodiment, RF signals are applied to the second set of rods Q0B, as well. The RF signals applied to the first and the second sets of rods Q0A and Q0B provide radial focusing of the received ions through the process of collisional cooling, which in turn results in a smaller radial spread of the ion beam than that at the entrance of the first set of rods Q0A. One advantage of using the two sets of rods Q0A and Q0B, rather than a single rod set having the same length as combination of the two rod sets, is that a DC voltage offset applied between the two sets of rods Q0A and Q0B can help keep the ions moving without losing so much axial kinetic energy that they would come to a stop within that segment. Further, the DC voltage offset applied to the sets of rods Q0C and Q0D is selected to ensure that the axial kinetic energy of the ions will be low as they exit the mass filter Q0 region and pass through the lens IQ1 to reach the mass analyzer Q1. This can in turn help with the timing for the filling of the mass filter Q0 and transmission of the ions received by the mass filter Q0 to the downstream mass analyzer Q1.

For the third set of rods Q0C, in addition to RF signals being applied for providing radial confinement, DC resolving voltages are also applied across the rods of the third set Q0C to define the bandwidth window of the mass filter Q0. As noted above, no resolving DC voltages are applied to the rods of the first, second, and fourth sets Q0A, Q0B, and Q0D.

For each rod set (or rod segment), the phase of the RF signal applied to the A-pole is 180° shifted relative to the phase of the RF signal that is applied to the B-pole. Further, for the third set of rods Q0C, the resolving DC voltages applied to the A-pole and the B-pole have opposite polarities. By way of example, in some embodiments, the applied RF voltages can have a frequency in a range of about 500 kHz to about 2 MHz and can have a zero-to-peak voltage in a range of about 500 V to about 10 kV, though other frequencies and/or voltages can also be employed based, e.g., on specific applications.

The choice of the RF drive frequency can depend on the desired mass range, available voltage ranges of the power supplies and the field radius of the quadrupole mass filter. The Mathieu equations, reproduced below, can be used to determine the RF drive frequency based on Mathieu a and q parameters:

$$a = \frac{8 e U}{m {Ω}^{2} {r}_{0}^{2}} \qquad Eq . ( 1 )$$

$$q = \frac{4 e V}{m {Ω}^{2} {r}_{0}^{2}} \qquad Eq . ( 2 )$$

where e represents the ion charge, U represents the DC resolving voltage, V represents the RF drive amplitude, r₀ represents field radius (i.e., the radius of the ion passageway provided by the quadrupole rods), 2 represents the angular drive frequency, and m represents the ion mass.

Table 2 below presents some example of the above parameters:

TABLE 2

| | | RF Amplitude, zero- | Resolving DC |
|---|---|---|---|
| | | to-peak, pole-to- | voltage, pole-to- |
| Drive Freq. | Field Radius | ground at m/z 2000 | ground at m/z 2000 |
| (Hz) | (mm) | (volts) | (volts) |
| 500,000 | 4.17 | 628 | 105.7 |
| 1,000,000 | 4.17 | 2513 | 422.6 |
| 2,000,000 | 4.17 | 10,051 | 1691 |

At very low RF drive frequencies, scattering losses for low mass ions increases. At very high RF drive frequencies, the cost of implementation of the required high RF voltages, such as the cost of voltage feedthroughs and cables, for radially confining, e.g., a maximum mass of 2000 Da at an RF drive frequency of 1 MHz becomes too high. The field radius can also be reduced to allow a higher frequency to be used with lower RF and DC amplitudes while still providing a mass range of 2000 Da. Although reducing the field radius can allow the use of lower RF and DC voltages, it may lead to an overall reduction in the number of transmitted ions, especially for intense ion beams and their associated space charge effect.

In this embodiment, the RF voltage source applies an RF signal, e.g., with a frequency and a voltage in the aforementioned ranges to the Q0C segment and the RF voltages for application to the Q0A, Q0B, and Q0D segments are derived, via capacitive coupling, from the Q0C voltage. In this embodiment, the peak-to-zero amplitudes of RF voltages applied to the Q0A, Q0B, and Q0D segments are about 90% of the respective RF voltage amplitude applied to the Q0C segment. The RF voltages generate an electric field for radial confinement of the ions as they pass through various segments of the mass filter Q0. Further, in this embodiment, the DC voltage source 20a applies the required DC offset voltages depicted in the FIG. 3 to the ion guide QJet® and various segments of the mass filter Q0 to generate an axial DC electric field for facilitating the axial movement of the ions through the mass filter Q0.

The DC potential drops between various segments can range, for example, from 0 V, where the ions are not helped in their axial movement, to the optimized potentials shown in FIG. 3 for moving the ions such that the ions will not stop in any of the segments, for example, a voltage drop of 10 V between QUA and Q0B, a 6 V drop between Q0B and Q0C and a 4 V drop between Q0C and Q0D.

In some embodiments, at least a portion of ions received by the mass filter Q0 can be fragmented within its upstream segments (e.g., Q0B in this embodiment) before arriving at Q0C. By way of example, the voltage drop between QUA and Q0B can be up to 200 V when used to fragment ions prior to entering Q0C, for the case of flow through MS3. In such embodiments, a bandpass window is applied to Q0C around the fragment ion to be selected by the downstream mass analyzer Q1. Potentials drops of up to 200 V can also be applied between QJet®/IQ0 and IQ0/Q0A for the purposes of fragmenting ions as they transition between QJet® and IQ0 and/or between IQ0 and Q0A.

In other embodiments, other voltages can be applied to the ion guide QJet® and the segments of the mass filter Q0 to generate an electric field for facilitating the axial movement of the ions through the mass filter Q0.

The mass analyzer Q1 that is positioned downstream of the mass filter Q0 receives the ions transmitted through the mass filter Q0 and selects from the received ions those that have a desired m/z ratio for transmission to downstream components of a mass spectrometer, as discussed in more detail below.

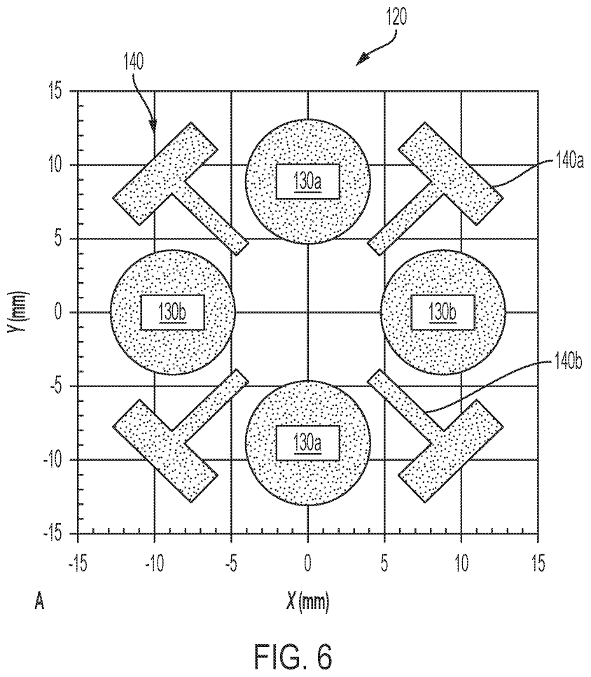

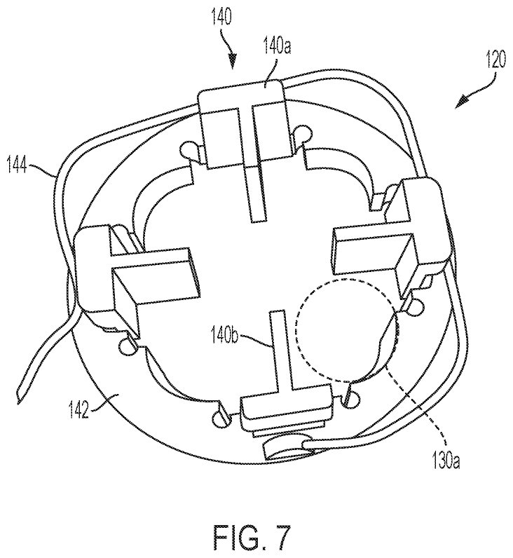

In other embodiments, a mass filter described in U.S. Pat. No. 10,741,378 (the “'378 Patent”) entitled “RF/DC Filter to Enhance Mass Spectrometer Robustness,” which is herein incorporated by reference in its entirety can be employed. Briefly, FIGS. 2 and 3 of the '378 Patent, which are reproduced herein as FIGS. 6 and 7, describe an ion guide 120 that includes a set of four rods 130a and 130b that extend from a proximal, inlet end disposed adjacent the inlet orifice to a distal, outlet end that is disposed adjacent the exit aperture. The rods 130a and 130b are arranged according to a quadrupole configuration to form a quadrupole rod set 130 that surrounds a space through which ions can travel from the inlet end to the outlet end. Similar to the previous embodiment, each of the rods 130 can be electrically coupled to an RF power supply (not shown in FIGS. 6 and 7) such that the rods on opposed sides of the central axis together form a rod pair to which a substantially identical RF signal is applied, and the phase of the RF signal applied to one rod set is opposite to the respective phase of the RF signal applied to the other rod set. A DC offset voltage can also be applied to the rods of the quadrupole rod set.

With continued reference to FIGS. 6 and 7, the ion guide 120 additionally includes a plurality of auxiliary electrodes 140 that are interspersed between the rods of the quadrupole rods of the quadrupole rod set 130. Each of the auxiliary electrodes 140 can be coupled to a DC power supply for providing an auxiliary electrical signal thereto so as to control transmission of ions through the ion guide 120. For example, in some embodiments, a DC voltage equal to the DC offset voltage applied to the rods of the quadrupole rod set can be applied to the auxiliary electrodes.

Another mass filter that is suitable for use in the practice of the present teachings is described in the '371 Application entitled “RF/DC cutoff to reduce contamination and enhance robustness of mass spectrometry,” which is herein incorporated by reference in its entirety. Briefly, this publication discloses systems and methods that utilize a multipole ion guide that can receive ions from an ion source for transmission to downstream mass analyzers. The system can include auxiliary electrodes interposed within a quadrupole rods set to which RF and/or DC signals can be applied to control or manipulate the transmission of ions from the multipole ion guide. For example, one pair of the auxiliary electrodes can be maintained at a positive electric potential and another pair of the auxiliary electrodes can be maintained at a negative electric potential.

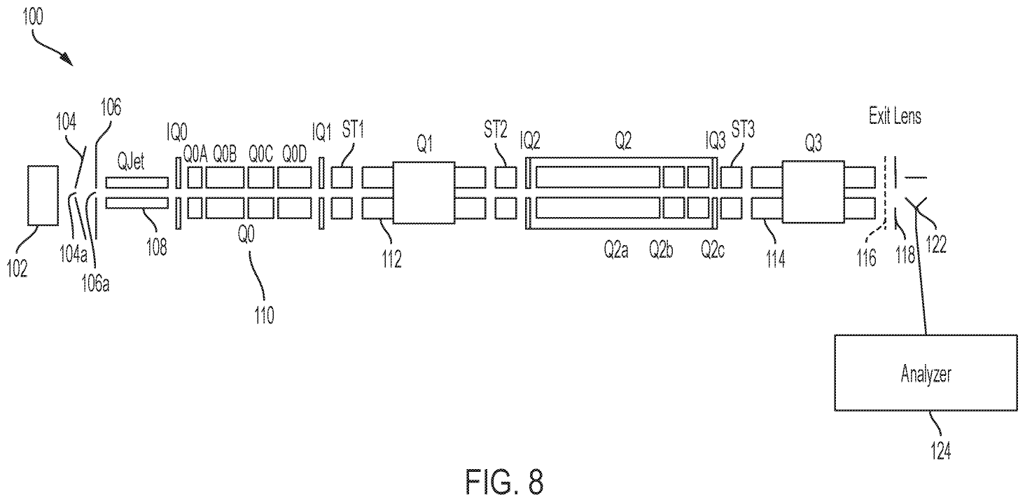

The present teachings can be incorporated in a variety of different mass spectrometers. By way of example, FIG. 8 schematically depicts a mass spectrometer 100, which includes an ion source 102 for generating a plurality of ions. A variety of ion sources can be employed in the practice of the present teachings. Some examples of suitable ion sources can include, without limitation, an electrospray ionization device, a nebulizer assisted electrospray device, a chemical ionization device, a nebulizer assisted atomization device, a chemical ionization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, among others.

The generated ions pass through an orifice 104a of a curtain plate 104 and an orifice 106a of an orifice plate 106, which is positioned downstream of the curtain plate 104 and is separated from the curtain plate 104 such that a gas curtain chamber is formed between the orifice plate 106 and the curtain plate 104. A curtain gas supply (not shown) can provide a curtain gas flow (e.g., of nitrogen) between the curtain plate 104 and the orifice plate 106 to help keep the downstream sections of the mass spectrometer clean by declustering and evacuating neutral particles. The curtain chamber can be maintained at an elevated pressure (e.g., a pressure greater than the atmospheric pressure) while the downstream sections of the mass spectrometer can be maintained at one or more selected pressures via evacuation through one or more vacuum pumps (not shown).

In this embodiment, the ions passing through the orifices 104a and 106a of the curtain plate 104 and the orifice plate 106 are received by an ion guide, QJet®, which comprises four rods 108 (two of which are visible in this figure) that are arranged in a quadrupole configuration to form an ion beam for transmission to downstream components of the mass spectrometer 100. In use, the ion guide QJet® can be employed to capture and focus the ions received through the opening of the orifice plate 106 using a combination of gas dynamics and radio frequency fields.

The ion beam exits the ion guide QJet® and is focused via a lens IQ0 into a first mass filter Q0, which is implemented in a manner discussed above. In some embodiments, the pressure of the first mass filter Q0 can be maintained, for example, in a range of about 3 mTorr to about 10 mTorr.

The first mass filter Q0 delivers the ions, via an ion lens IQ1, and a stubby lens ST1, which functions as a Brubaker lens, to a downstream second mass filter Q1, which is implemented in a manner discussed above.

More specifically, in this embodiment, the quadrupole rod set 110 of the second mass filter Q1 can be operated as a transmission RF/DC quadrupole mass filter for selecting ions having an m/z value of interest. By way of example, the quadrupole rod set 110 of the second mass filter Q1 can be provided with RF/DC voltages suitable for operation in a mass-resolving mode. For example, parameters of applied RF and DC voltages can be selected so that the second mass filter Q1 establishes a transmission window of a chosen m/z ratio, such that these ions can traverse the second mass filter Q1 largely unperturbed. Ions having m/z ratios falling outside the window, however, do not attain stable trajectories within the quadrupole and can be prevented from traversing the quadrupole rod set of the second mass filter Q1. It should be appreciated that this mode of operation is but one possible mode of operation for the second mass filter Q1.

In this embodiment, the ions selected by the second mass filter Q1 are focused via a stubby lens ST2 and an ion lens IQ2 into a collision cell Q2. In this embodiment, the collision cell Q2 includes a pressurized compartment that can be maintained, e.g., at a pressure in a range of about 1 mTorr to about 10 mTorr, though other pressures can also be used for this or other purposes. A suitable collision gas (e.g., nitrogen, argon, helium, etc.) can be provided by way of a gas inlet (not shown) to fragment at least a portion of the ions received by the collision cell Q2.

In this embodiment, the collision cell Q2 includes four rods that are arranged in a quadrupole configuration and to which RF voltages can be applied to provide radial confinement of the ions received by the collision cell Q2.

The product ions generated by the collision cell Q2 are received by a downstream quadrupole mass analyzer Q3 via an ion lens IQ3 and a stubby lens ST3, which function to focus the product ions into the quadrupole mass analyzer Q3. The quadrupole mass analyzer Q3 includes four rods 114 that are arranged relative to one another in a quadrupole configuration and to which RF and DC voltages can be applied in a manner known in the art to provide mass analysis of the product ions. The ions passing through the mass analyzer Q3 are detected by a downstream detector 122 that generates ion detection signals in response to the incident ions. A pair of lenses 116 and 118 help focus the ions onto the detector. In this embodiment, the lens 116 is implemented as a 90% transmission mesh that defines the end of the trapping region when using the Q3 as a linear ion trap. The lens 118 in turn provides shielding for the trap region which reduces the field penetration from the float potential applied to the detector (e.g., −6 kV in positive ion mode, +4 kV in negative ion mode for the 4822D channeltron detection system, or, from the −15 kV applied to the HED and +5.5 kV detector float potential used in the high dynamic range detection system, such as those described in U.S. Pat. Nos. 10,074,529 and 9,991,104, which are herein incorporated by reference in their entirety).

An analyzer 124 in communication with the detector 122 receives the ion detection signals and processes the ion detection signals to generate a mass spectrum of the product ions, thereby allowing monitoring MRM transitions corresponding to the precursor ions. As is known in the art, the analyzer 124 can be implemented in hardware/firmware and/or software using techniques known in the art as informed by the present teachings. For example, the analyzer 124 can include a processor, one or more random access memory (RAM) modules, one or more permanent memory modules and at least one communication bus for allowing communication among these and other components.

In related aspect, the present teachings provide methods and systems that help reduce contamination of high-vacuum components of a mass spectrometer, such as the quadrupole rods of the second mass filter Q1. The contamination of ion path components can adversely affect the performance of a tandem mass spectrometer. In general, contamination of high-vacuum components can degrade the performance of a mass spectrometer more than contamination of components used before the high-vacuum components, such as the quadrupole rods of the first mass filter Q0 or auxiliary electrodes such as those described in the '371 Application and the '378 Patent. For example, in DIA operating modes (herein also referred to as DIA methods), such as SWATH®, unwanted precursor ions having m/z ratios outside of the ion selection window of the second mass filter Q1 are filtered out and may be deposited onto the quadrupole rods of the second mass filter Q1. Such contamination can adversely affect the sensitivity and the shape of the ion selection windows of the second mass filter Q1, which can in turn reduce precursor ion transmission efficiency and effective coverage for the mass range of interest. Reduced coverage of the mass range of interest, in turn, affects the ion extraction and quantitation accuracy in SWATH® analysis.

Thus, some embodiments of the methods and systems according to the present teachings are directed to reducing the contamination of low pressure mass analyzer of a mass spectrometer operating in a DIA mode, thereby maintaining the instrument's sensitivity, precursor ion transmission efficiency, and coverage of the precursor ion mass range of interest.

By way of example, some embodiments of the present teachings provide methods and systems for performing mass spectrometry in a SWATH® mode in which only the rod set of the first mass filter Q0 is employed for the selection of the precursor ions or the ion transmission bandwidth of the first mass filter Q0, which is configured for prefiltering the precursor ions, is selected to be larger than the ion transmission window provided by the downstream second mass filter Q1. Such embodiments may thus reduce the contamination of the second mass filter Q1 when the mass spectrometer is operated in a SWATH® mode.

In various embodiments, contamination of a tandem mass spectrometer operating in a DIA mode is reduced by performing mass filtering in a multipole ion guide Q0, e.g., quadrupole ion guide. The ion guide Q0 can perform the mass filtering typically done by a mass filter device Q1 (e.g., a mass filter device formed by using a set of multipole rods, such as quadrupole rods) or the ion guide Q0 can perform prefiltering to improve the mass filtering done by a mass filter Q1. In other words, a mass filtering ion guide Q0 can be used to replace a mass filter Q1 in a DIA method or it can be used to prefilter precursor ions for a mass filter Q1 in a DIA operating mode.

In any DIA method, different precursor ion mass selection windows that span a precursor ion m/z or mass range of interest are selected for an experiment. These different precursor ion mass selection windows are selected by a user or method developer of the DIA method. During each time cycle of the tandem mass spectrometer, each of these different precursor ion mass selection windows is used to transmit precursor ions to a fragmentation device. Note that the terms “mass” and “m/z” are used interchangeably herein. Generally, mass spectrometry measurements are made in m/z and converted to mass by multiplying by charge.

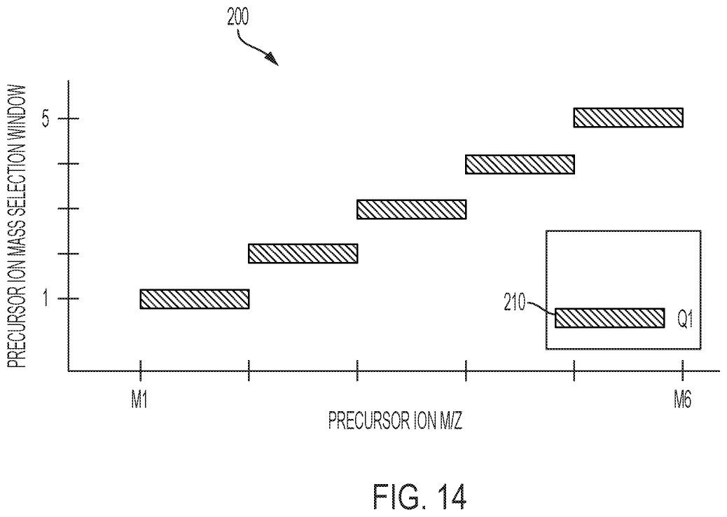

FIG. 14 is an exemplary diagram 200 showing how different precursor ion mass selection windows that span a mass range are scanned in a conventional DIA method, upon which various embodiments may be implemented. In this example, five different precursor ion mass selection windows 210 are selected for a DIA method to span a precursor ion mass range of between M1 and M6. In FIG. 14, different precursor ion mass selection windows 210 are shown as nonoverlapping windows, with the ion mass selection windows having the same length or width. However, these ion selection windows can also be overlapping windows and/or have variable lengths.

In the DIA method, the precursor ions in each of different precursor ion mass selection windows 210 is transmitted and fragmented, and the resulting product ions are mass analyzed in each time cycle of a tandem mass spectrometer. As a result, five MS/MS spectra are produced for each time cycle of the tandem mass spectrometer. Each MS/MS spectrum can be acquired at a single collision energy or averaged over a range of collision energies during fragmentation.

In the example of FIG. 14, each of different precursor ion mass selection windows 210 is selected and transmitted using a mass filter device in the high-vacuum region of the tandem mass spectrometer. The mass filter device can, for example, be a quadrupole Q1.

In other embodiments, a multipole ion guide Q0 can perform mass filtering or prefiltering by using different Q0 precursor ion mass selection bandwidths. For mass filtering, each window of the different Q0 precursor ion mass selection windows is substantially equivalent to or wider than each window of the different precursor ion mass selection windows selected for the DIA method. In other words, for mass filtering, the different Q0 precursor ion mass selection windows are equivalent to or wider than the different precursor ion mass selection windows selected for the DIA method.

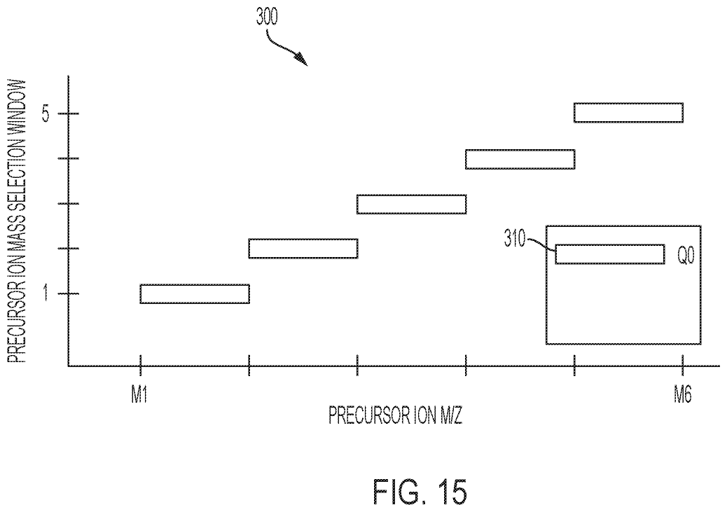

FIG. 15 is an exemplary diagram 300 showing how a multipole ion guide Q0 can perform mass filtering by using different Q0 precursor ion mass selection windows, in accordance with various embodiments. In FIG. 15, five different Q0 precursor ion mass selection windows 310 are selected for a DIA method to span a precursor ion mass range of between M1 and M6. Again, in FIG. 15, different Q0 precursor ion mass selection windows 310 are shown as nonoverlapping windows that all have the same length or width. However, these windows can also be overlapping windows and can have variable lengths.

In the DIA method, each of different precursor ion mass selection windows 310 is selected and transmitted using a multipole ion guide (e.g., quadrupole) as a mass filter Q0 prior to the low pressure region. In addition, no other mass filter devices, such as a quadrupole mass filter Q1 or a second mass filter, are used. Ions transmitted by the mass filter Q0 are sent to a fragmentation device, and the resulting product ions are mass analyzed in each time cycle of the tandem mass spectrometer. Again, five MS/MS spectra are produced for each time cycle of the tandem mass spectrometer. Each MS/MS spectrum can be acquired at a single collision energy or averaged over a range of collision energy during fragmentation.

In such embodiments, eliminating the need for a second mass filter device, such as a quadrupole Q1, significantly reduces the contamination problem in the low pressure regions of the tandem mass spectrometer. It also reduces the complexity of the instrument. Generally, a second mass filter device can provide a higher mass resolution than using a single ion guide mass filter. However, because wide precursor ion mass selection windows are used in DIA experiments, the reduced mass resolution of the ion guide mass filter Q0 does not pose any problem.

In various embodiments, however, a multipole ion guide mass filter Q0 can also be used as a prefilter for a second mass filter Q1. In mass prefiltering, each window of a plurality of precursor ion mass selection windows for the first mass filter Q0 is used to prefilter ions for a corresponding window of a plurality of different precursor ion mass selection windows for the second mass filter Q1 that are employed for implementing the DIA method. As a result, a precursor ion mass selection window of the first mass filter Q0 is configured to have larger mass or m/z width than its corresponding precursor ion mass selection window of the second mass filter Q1.

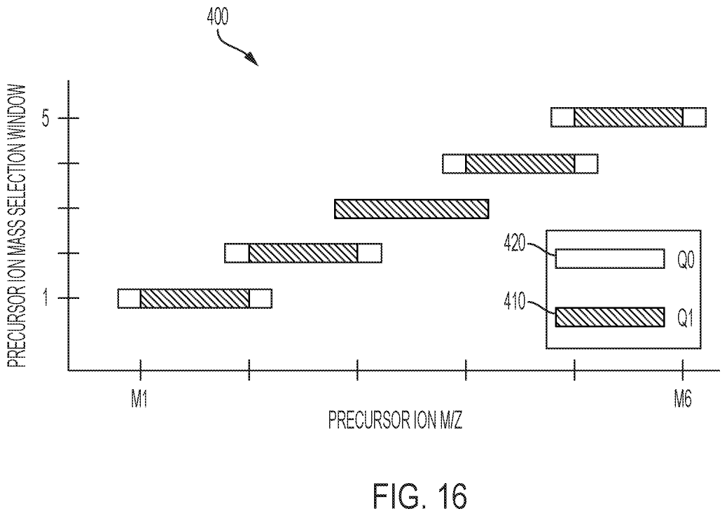

FIG. 16 is an exemplary diagram 400 showing how an ion guide can perform mass prefiltering by using precursor ion mass selection windows of the first mass filter Q0 to prefilter precursor ion mass selection windows of the second mass filter Q1, in accordance with various embodiments. In FIG. 16, five different precursor ion mass selection windows 410 of the second mass filter Q1 are selected for a DIA method to span a precursor ion mass range of between M1 and M6. In addition, each window of five different precursor ion mass selection windows 420 of the first mass filter Q0 is calculated to prefilter a window of the five different precursor ion mass selection windows 410 of the second mass filter Q1.

As shown in FIG. 16, each window of different precursor ion mass selection windows 420 of the first mass filter Q0 has a larger bandwidth than its corresponding window of different precursor ion mass selection windows 410 of the second mass filter Q1. In this example, each window 420 of the first mass filter Q0 has a lower low m/z cutoff and a higher high m/z cutoff than its corresponding ion selection window 410 of the second mass filter Q1. This reduces both low mass contamination and the much more troubling high mass contamination.

Prefiltering ions is not without cost, however. As described below, there is at least a cost in the time needed for refilling the first mass filter Q0. As a result, in various embodiments, one window of the first mass filter Q0 can be used to prefilter two or more windows of the second mass filter Q1. In some such embodiments, the window of the first mass filter Q0 spans a range of m/z ratios that is greater than the combined range of m/z ratios associated with two consecutive ion selection windows of the second mass filter Q1.

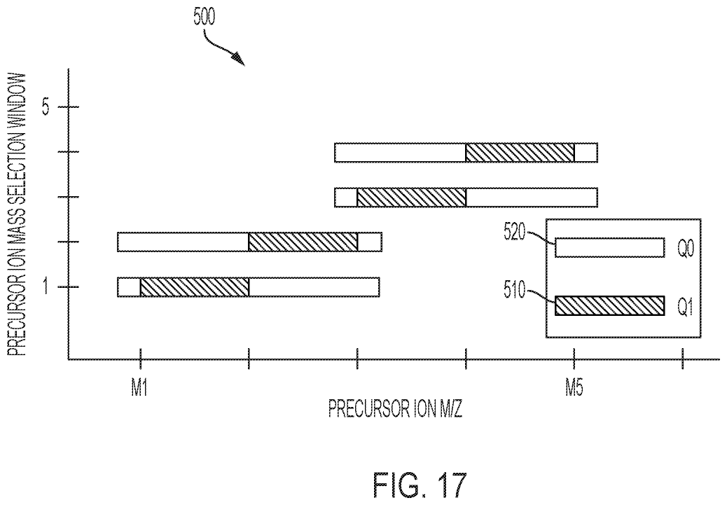

By way of example, FIG. 17 is a diagram 500 showing how an ion guide Q0 can perform mass prefiltering using one precursor ion mass selection window to prefilter two different precursor ion mass selection windows for the second mass filter Q1, in accordance with various embodiments. In FIG. 17, four different precursor ion mass selection windows 510 of the second mass filter Q1 are selected for a DIA method to span a precursor ion mass range of between M1 and M5. In addition, each window of two different precursor ion mass selection windows 520 of the first mass filter Q0 is calculated to prefilter two windows of the four different precursor ion mass selection windows 510 of the second mass filter Q1. While this example shows a bandpass window of the first mass filter Q0 covering two different precursor ion mass selection windows of the second mass filter Q1, it is also possible for a bandpass window of the first mass filter Q0 to cover more than two different selection windows, e.g., 3, 4, 5, etc., for the second mass filter Q1.

In various embodiments, mass filtering or prefiltering by the first mass filter Q0 can be performed by applying a tailored waveform to ion guide rods, e.g., using a plurality of segmented ion guide rods, or using auxiliary electrodes placed between ion guide rods. By way of example, in some embodiments, a tailored waveform can be applied by applying a comb of different frequencies to the rods of a multipole ion guide (i.e., a first mass filter Q0). The comb of different frequencies specifies masses that are not transmitted. In other words, a precursor ion mass selection window of the first mass filter Q0 is formed by excluding masses outside of the window by applying RF signals to the rods of the multipole ion guide with corresponding frequencies.

### Segmented Multipole Ion Guide Rods

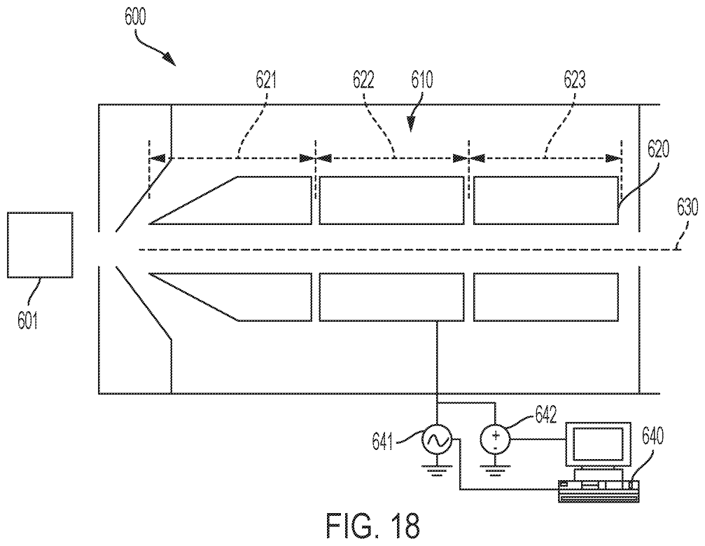

FIG. 18 is an exemplary diagram 600 of a multipole ion guide 610, which can be used as a mass filter Q0, with segmented rods that can be used for mass filtering or prefiltering, in accordance with various embodiments. The multipole ion guide 610 includes segmented rod set 620. Each rod of segmented rod set 620 is spaced from and extends alongside central longitudinal axis 630. Each rod of segmented rod set 620 is also segmented into three different longitudinal segments. These segments are first segment 621, middle segment 622, and final segment 623. First segment 621 is used to receive and cool ions entering the multipole ion guide 610 from ion source 601. Final segment 623 is used to transmit ions from the multipole ion guide 610. Middle segment 622 is used for filtering or prefiltering ions.

As in a conventional quadrupole mass filter Q1, an RF voltage 641 of an RF electrical signal and a DC voltage 642 of a DC electrical signal are applied to rod segments of middle segment 622. A processor or controller 640 applies or controls these electrical signals. RF voltage 641 specifies the low m/z cutoff of the precursor ion mass selection window for the multipole ion guide 610 (i.e., the mass filter Q0), and DC voltage 642 specifies the high m/z cutoff of the precursor ion mass selection window for the multipole ion guide 610 (i.e., the mass filter Q0). It will be apparent to those of skill in the relevant arts that a segmented mass filter Q0 can comprise any number of segments and any segment can be used for filtering or prefiltering ions.

### Auxiliary Electrodes Between Multipole Ion Guide Rods

The '832 Application and the '371 Application, mentioned above, describe systems and methods that utilize a multipole ion guide Q0 that can receive ions from an ion source for transmission to downstream mass spectrometer components but prevent contaminating ions from being transmitted into the low pressure chamber of a mass spectrometer. The '832 Application and the '371 Application are incorporated herein by reference in their entireties. A DC signal is provided to auxiliary electrodes interposed within a multipole rod set to control or manipulate the transmission of ions from the multipole ion guide Q0.

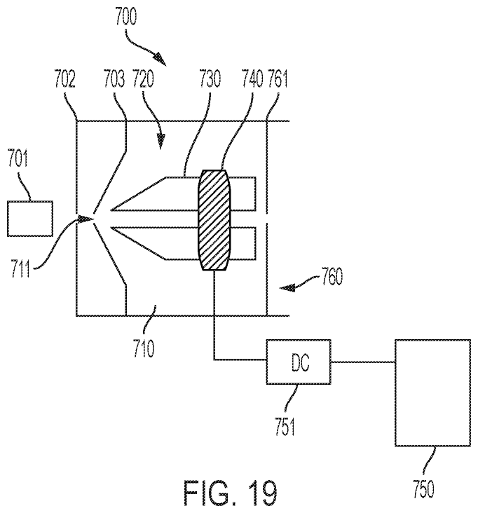

FIG. 19 is an exemplary diagram 700 showing the multipole ion guide 720 (i.e., Q0) of the '832 Application and the '371 Application, upon which various embodiments may be implemented. In FIG. 19, ions generated by an ion source device 701 can be extracted into a coherent ion beam by passing successively through apertures in an orifice plate 702 and skimmer 703. The ions form a narrow and highly focused ion beam that enters ion guide chamber 710 through skimmer aperture 711.

The multipole ion guide 720 is housed within an ion guide chamber 710. Rods of multipole rod set 730 surround and extend along a central axis of multipole ion guide 720, thereby defining a space through which ions of the highly focused ion beam are transmitted. The multipole ion guide 720 also includes auxiliary electrodes 740 extending along a portion of multipole ion guide 720 and interposed between the rods of multipole rod set 730.

The multipole ion guide 720 uses multipole rod set 730 and auxiliary electrodes 740 to bandpass filter ions of the highly focused ion beam. An RF voltage and a DC offset voltage are applied to the rods of multipole rod set 730. The RF voltage specifies a low m/z cutoff for the bandpass filter. A DC voltage 751 is applied to auxiliary electrodes 740. DC voltage 751 is applied using processor or controller 750, for example. The relative difference between DC voltage 751 and the DC offset voltage applied to the rods of multipole rod set 730 specifies a high m/z cutoff for the bandpass filter. In other words, DC voltage 751 of auxiliary electrodes 740 is used to specify the high m/z cutoff for the bandpass filter.

Ions filtered by multipole rod set 730 and auxiliary electrodes 740 of the multipole ion guide 720 are transmitted to low pressure chamber 760. The ions are transmitted from ion guide chamber 710 to low pressure chamber 760 through an IQ1 lens 761, for example. It will be apparent to those of skill in the relevant arts that a mass spectrometer may include additional vacuum stages which may include additional ion guides. In some of the above embodiments, the present teachings can be implemented by configuring ion guides and mass filters employed in SCIEX brand mass spectrometers. The ion guide Q0 typically operates within a vacuum stage that has approximately 1-12 mTorr pressure range, though other pressures may also be employed. Other ion guides may also be used to create the bandpass, including ion guides that operate in various other pressure regimes.

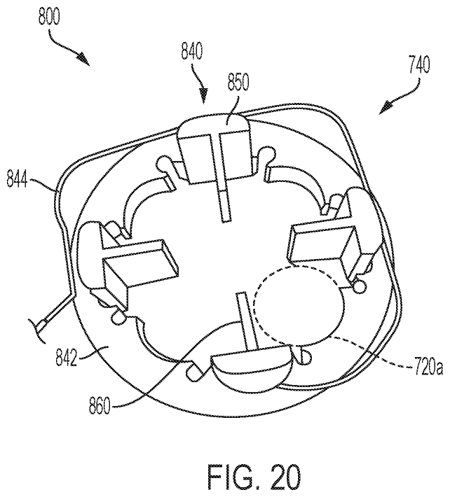

FIG. 20 is an exemplary perspective view 800 of the auxiliary electrodes of the '832 Application and the '371 Application, upon which various embodiments may be implemented based on the present teachings. As shown in FIG. 20, auxiliary electrodes 740 can include four T-shaped electrodes 840 having a base portion 850 and a stem portion 860 extending therefrom. Electrodes 840, can be 10 mm in length and stem 860 can be approximately 6 mm in length. Electrodes 840 can be coupled to a mounting ring 842 that can be mounted to a desired location of a multipole ion guide. In other embodiments, electrodes 840 can have different lengths and stem 860 can have different lengths. The electrode dimensions can be optimized for different workflows or ion guide rod geometries.

The exemplary mounting ring 842 can include notches for securely engaging rods of the multipole ion guide (e.g., as with rod 720a, shown in phantom). As shown, a single lead 844 can be coupled to a DC power supply (not shown) and can also be electrically coupled to one or more of electrodes 840. The same DC voltage can be applied to all of electrodes 840 or different DC voltages can be applied to the different electrodes 840. In some embodiments opposite electrodes may have a positive DC potential and the adjacent pair may have a negative DC potential. In additional embodiments the potentials applied to the two pairs of electrodes can be offset or symmetrically disposed around the DC offset potential of the Q0 rods.

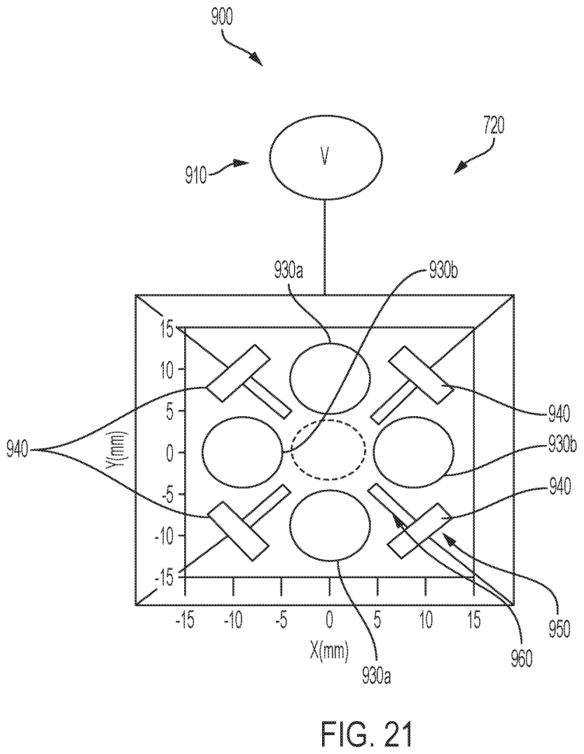

FIG. 21 is an exemplary cross-sectional view 900 of the multipole ion guide Q0 of the '371 Application, upon which various embodiments may be implemented. In FIG. 21, the multipole ion guide 720 is depicted as a quadrupole that includes a set of four rods 930a and 930b. Rods 930a and 930b surround and extend along a central axis of the multipole ion guide 720, thereby defining a space through which the ions are transmitted.

The multipole ion guide 720 further includes a plurality of auxiliary electrodes 940 interposed between quadrupole rods 930a and 930b of the multipole ion guide 720 that also extend along a central axis (shown in phantom). Each auxiliary electrode 940 can be separated from another auxiliary electrode 940 by a rod of quadrupole rods 930a and 930b. Further, each of the auxiliary electrodes 940 can be disposed adjacent to and between a rod 930a of the first pair and a rod 930b of the second pair.

While quadrupole rods 930a and 930b are maintained at a DC offset voltage with a first RF voltage applied to the first group of rods 930a at a first frequency and in a first phase and a second RF voltage (e.g., of the same amplitude (Vp-p) as the first RF voltage) at a opposite phase applied to the second group of rods 930b, a variety of auxiliary electrical signals can be applied to the auxiliary electrodes 940. As shown in FIG. 21, each auxiliary electrode 940 has a DC voltage 910 of the same amplitude. In other words, all T-shaped electrodes 940, each with base portion 950 and a stem portion 960, are biased at the same DC voltage 910. However, as described previously, in some embodiments one pair of electrodes is biased with a positive potential relative to the DC offset voltage of the rods and the other pair of electrodes can be biased with a negative potential relative to the DC offset potential of the rods. In some embodiments, the positive and negative potential biases may have the same magnitude.

Each auxiliary electrode 940 has a DC voltage that is different from the DC offset voltage 910 that is applied to quadrupole rods 930a and 930b. As a result, as explained in the '371 Application, a mass windowing device for a multipole ion guide is created.

Although the '832 Application and the '371 Application show that auxiliary electrodes can be applied to a multipole ion guide Q0 in order to filter ions in tandem mass spectrometry, heretofore it was not thought possible to do this in a DIA method. In other words, it was not thought possible to produce two or more different precursor ion mass selection windows within the same cycle of a tandem mass spectrometer using a multipole ion guide Q0 with auxiliary electrodes or with any multipole ion guide Q0 at all.

DIA methods require a consistent and reproducible bandpass window for a given RF voltage and auxiliary electrode DC voltage to the multipole ion guide Q0 when precursor ion windows are moved in stepped sizes or scanning manner. In addition, DIA methods require that the bandpass or precursor ion mass selection windows of the multipole ion guide Q0 be changed as quickly as the precursor ion mass selection windows of the mass filter Q1 without limiting the cycle time of a tandem mass spectrometer.

The following Examples are provided for further illustration of various aspects of the present teachings, and not necessarily to indicate the optimal ways of practicing the present teachings or optimal results that may be obtained. Hereinbelow, when “Q0” modifies other terms, the modified terms will be understood to be associated with a multi pole ion guide, a mass filter, a first mass filter, a prefilter, or the like, which are implemented with a structure comprising multiple sets of rods positioned in series as Q0 shown in FIGS. 3 and 8. When “Q1” modifies other terms, the modified terms will be understood to be associated with a mass analyzer, a mass filter, a second mass filter, or the like, which are implemented with a structure shown as Q1 in FIGS. 3 and 8.

### Example 1

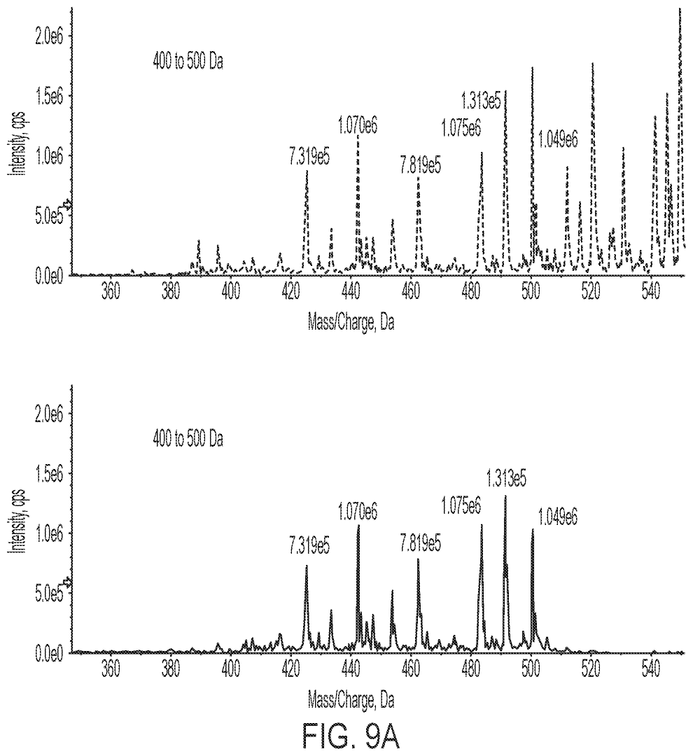

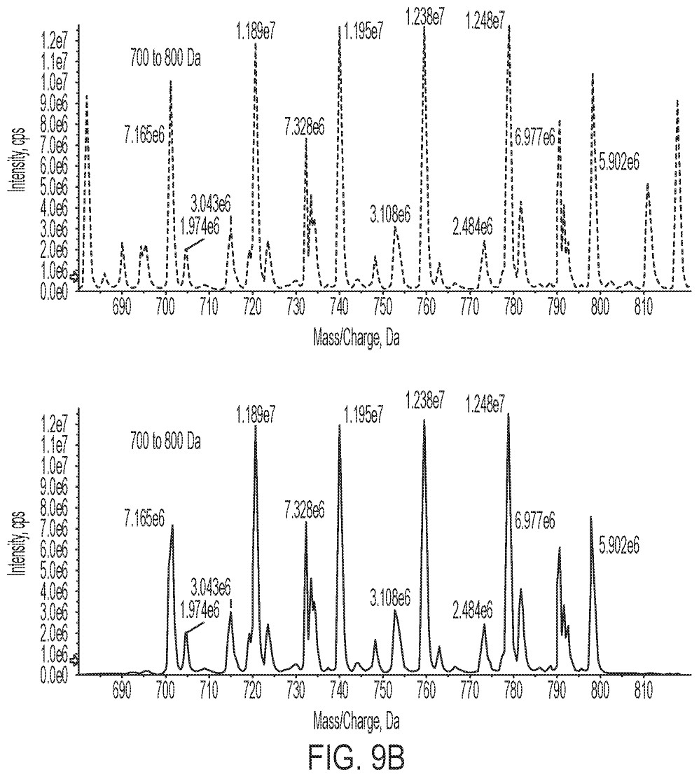

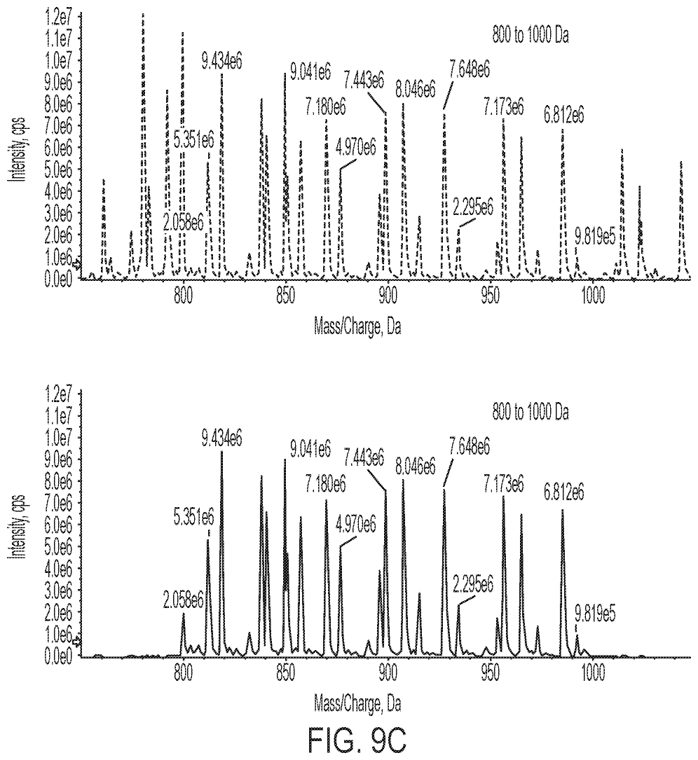

FIGS. 9A, 9B, and 9C show examples of bandpass windows that were obtained for a four-segment mass filter Q0, such as that schematically depicted in FIG. 3, via application of suitable RF and resolving DC voltages to various rods of the mass filter Q0 in a manner discussed above.

More specifically, FIG. 9A shows a bandpass window ranging from about 400 to about 500 Da. This bandpass window was achieved by applying an RF signal having a frequency of 1.0 MHz and zero-to-peak voltage amplitude of 421.5 volts to Q0C, with the voltages applied to Q0A, Q0B, and Q0D, which are capacitively coupled to Q0C, being about 90% of the voltage applied to Q0C. The resolving DC voltage on the A-pole was +73.4 V and on the B-pole was −73.4 V, which in combination with an offset voltage of −6 V can result in a total voltage of +67.4 on the A-pole and −79.4 on the B-pole. The bandpass window is determined only by the resolving DC voltage, and the offset DC voltage determines the axial kinetic energy of the ions and helps ions continue their axial motion.

FIG. 9B shows a bandpass window ranging from about 700 Da to about 800 Da achieved by applying RF signals with a frequency of 1.0 MHz and a zero-to-peak, pole to ground amplitude of 899.6 volts and a resolving DC voltage having an amplitude, pole to ground of 136.1 volts.

FIG. 9C shows a bandpass window ranging from about 800 to about 1000 Da achieved by applying RF signals with a frequency of 1.0 MHz and a zero-to-peak, pole to ground amplitude of 1009.0 volts and a resolving DC voltage having an amplitude, pole to ground of 146.8 volts.

### Example 2

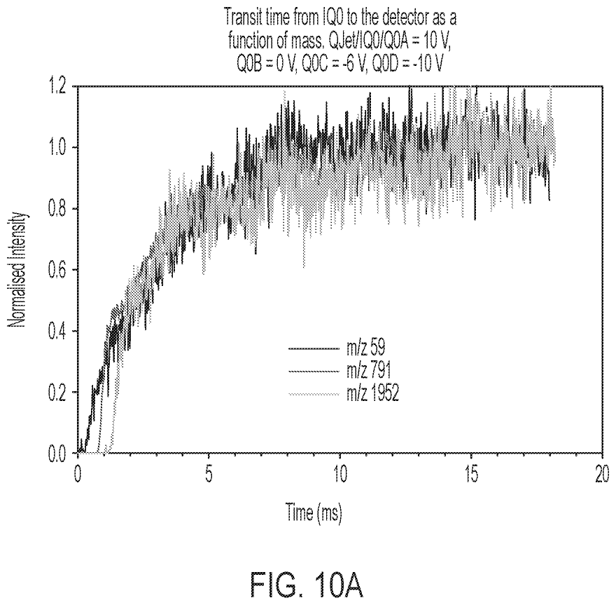

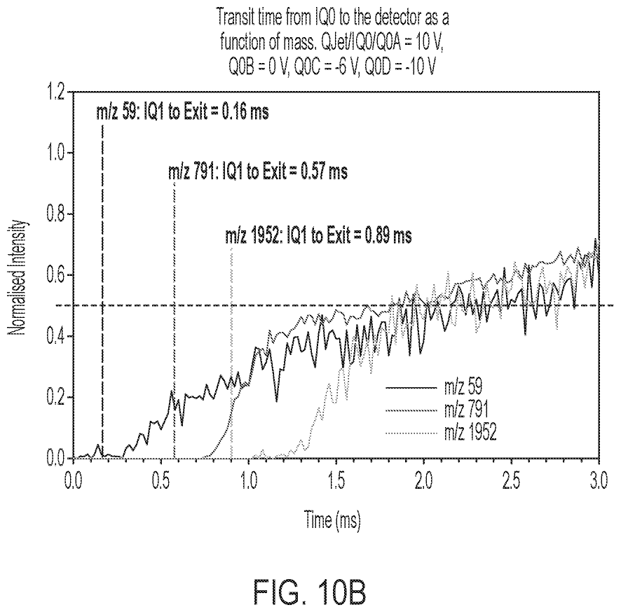

A mass spectrometer as shown in FIG. 3 was employed for obtaining the data discussed in this section. In particular, the measurements presented in FIGS. 10A and 10B were accomplished using the mass filter Q0 that is depicted in FIG. 3 along with a 45° ST1 that inhibits ion trapping in the ST1 region and a 37° ST3 to prevent ion trapping in ST3. The presented data was collected with CAD=0. Higher CAD settings would have the effect of further slowing down the ion transit times due to collisions in the collision cell Q2.

More specifically, FIG. 10A shows the transit time from the lens IQ0 to the detector 122 as a function of ion mass for the following DC settings of the QJet® ion guide and various segments of the mass filter Q0: QJet®/IQ0/Q0A=+10 V, Q0B=0 V, Q0C=−6 V, and Q0D=−10 V. FIG. 10B shows a time segment of the data presented in FIG. 10A extending from t=0 to t=3 milliseconds. Further, the vertical broken lines represent the calculated transit time for the associated mass from the ion lens IQ1 to the exit lens 118. The time from the output exit lens to the output of the digital pulse is negligible due to the high fields present in the detector region. A Tektronix DPO 7254C high speed oscilloscope was used to monitor the digital pulses created when an ion was detected. The oscilloscope was triggered by a pulse that was used to the switch the lens IQ0 from a non-transmitting mode to a transmitting mode. In this example, 200 acquisitions were used to build up the histogram presented in FIGS. 10A and 10B.

These measurements show that in the depicted example, if the time for the mass analyzer Q1 to perform a measurement is about 3 milliseconds, when the mass analyzer Q1 switches to the next m/z ratio, the intensity of the next m/z ion will be at the 60% level if the next ion (e.g., m₂ in the above description) were contained within the bandpass window of the mass filter Q0. In such a case, the mass analyzer Q1 measurements can begin as soon as the mass analyzer Q1 is switched to the next ion without waiting for the bandpass of the mass filter Q0 to switch.

The above-described technique can also be extended to the SWATH® acquisition method where two or more SWATH® precursor windows are included in the bandpass window of the first mass filter Q0. SWATH® acquisition is a Data Independent Acquisition (DIA) method where all precursor ions in a defined or selected precursor ion mass selection window of the second mass filter Q1 are transferred to a fragmentation device or collision cell to generate one MS/MS spectrum. The SWATH® acquisition mode is normally performed on a TOF MS instrument. In such cases, the ion optics after the collision cell Q2 can be the TOF ion optics. In a typical SWATH®, the precursor ion mass selection windows of the second mass filter Q1 are sequentially stepped across the entire precursor ion mass range of the analysis. The time it takes to analyze the entire mass range once is referred to as cycle time. Cycle time is limited by the chromatographic peak resolution, where enough points need to be acquired across one LC peak to determine its shape. To keep the cycle time constant during the analysis, adjustments between MS/MS accumulation time, entire precursor mass range and precursor mass selection window width are required.

MS/MS accumulation time is the time spent on each precursor ion window to collect MS/MS information. Generally better selectivity can be achieved with narrow precursor windows while better sensitivity can be achieved with wider windows using longer MS/MS accumulation.

For example, in a nanoflow proteomics analysis with peptides masses ranging from 400 Da to 1250 Da, the MS/MS accumulation time can range from 50 ms to 100 ms and precursor windows of the second mass filter Q1 can range from 10 Da to 100 Da. In some cases, when narrow precursor windows are applied (e.g., 3 Da) through the entire mass range, the MS/MS accumulation can be reduced to as short as 20 ms to maintain the cycle time. In such cases where one or more narrow precursor windows are selected in one SWATH® method or conditions which require applying short MS/MS accumulation, two or more precursor windows can be included in one bandpass window of the first mass filter Q0 as bandpass windows of the second mass filter Q1 shift along with SWATH® precursor windows.

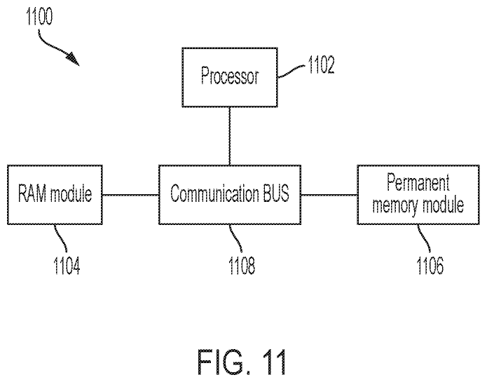

As noted above, a controller employed for practicing various aspects of the present teachings as discussed above can be implemented in hardware/firmware/software or combination thereof. By way of example, FIG. 11 schematically depicts an example of an implementation of a controller 1100, which includes a processor 1102, a random access memory (RAM) module 1104, a permanent memory module 1106, and a communication bus 1108 that allows the processor 1102 to communicate with other components of the controller 1100. In some embodiments, various instructions for performing different functions of the controller 1100, e.g., activating and deactivating an electrostatic deflector and/or analyzing detection signals generated by an ion detector, can be stored in the permanent memory module 1106 and can be transferred to the RAM module 1104 during runtime by the processor 1102, which can execute those instructions for performing the respective functions.

### Example 3

In order to determine if a multipole ion guide Q0 with auxiliary electrodes can be used for DIA methods, several experiments were conducted. These experiments investigated Q0 bandpass performance. These experiments were conducted using a separate Q0 RF power supply on a modified tandem mass spectrometry system. The multipole ion guide Q0 used was a Q0 quadrupole with four T-shaped auxiliary electrodes (T-bars) interposed between the rods of the quadrupole. Both auxiliary electrode DC potentials (QTB, the potential difference between two pairs of T-bar electrodes) and Q0 RF voltages (Q0A, Vp-p) were adjustable, using firmware/software modified to enable these two parameters to be varied.

These experiments were conducted to determine: (1) if varying the voltages applied to the T-bars and the rods of the quadrupole Q0 can produce a wide selection of Q0 precursor ion mass selection window widths and locations: (2) if Q0 precursor ion mass selection windows are reproducible: (3) if Q0 precursor ion mass selection windows are consistent for a range of different compounds: (4) if Q0 precursor ion mass selection windows are independent of the magnitude of the transmitted ion current; and (5) if Q0 quadrupole refill time substantially affects the cycle time of the tandem mass spectrometer.

### (1) Window Location and Width as a Function of Quadrupole and T-Bar Voltages

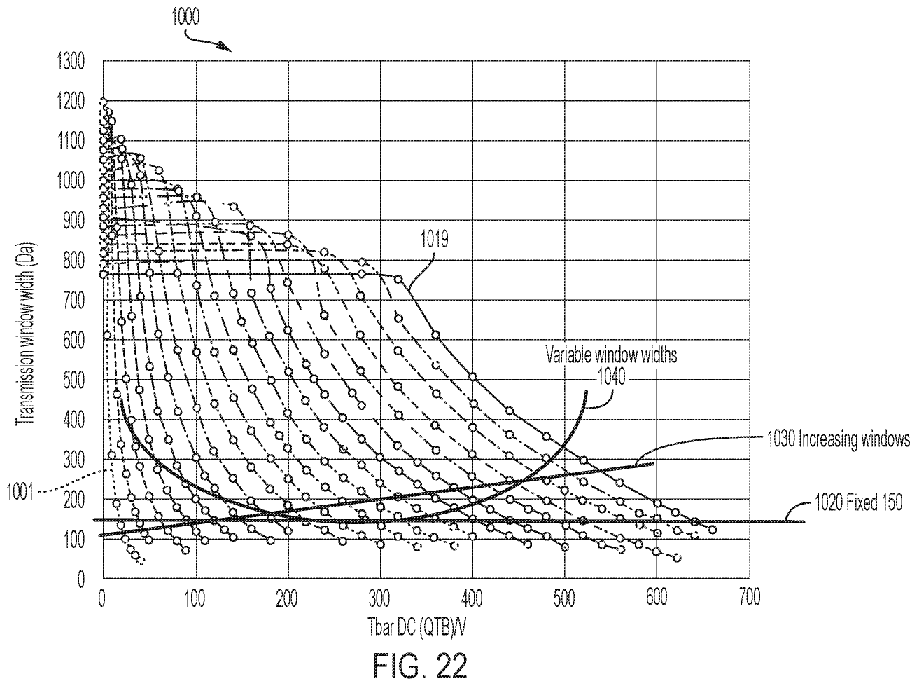

FIG. 22 is an exemplary plot 1000 showing how different RF voltages applied to quadrupole rods produce different precursor ion mass selection window widths with different DC voltages applied to the T-bar electrodes interposed between the quadrupole rods of a multipole ion guide Q20, in accordance with various embodiments. In plot 1000, the different lines connecting data points represent increasing RF voltages (Vp-p, 19 voltages from 200 to 2000 V in increasing increments of 100 V) applied to quadrupole rods. For example, line 1001 connects the values measured when an RF voltage of 200 V is applied to the quadrupole rods of the multipole ion guide Q0. Similarly, line 1019 connects the values measured when an RF voltage of 2000 V is applied to the quadrupole rods of the multipole ion guide Q0.

Plot 1000 shows that varying the voltages applied to the T-bars and the rods of a quadrupole Q0 can produce a wide selection of Q0 precursor ion mass selection window widths and locations. As described above, the RF voltage applied to the quadrupole rods specifies the low m/z cutoff, which defines the location of the Q0 precursor ion mass selection window. The DC voltage applied to the T-bars specifies the width of the Q0 precursor ion mass selection window, which, in turn, provides the high m/z cutoff.

Plot 1000 shows that, for a given location in the precursor ion mass range (specified by a particular RF quadrupole voltage), the width of the Q0 precursor ion mass selection window (specified by a particular DC T-bar voltage) can be varied over a wide range (for example, from 100-1000 Da). Plot 1000 also shows that this is possible over a wide range of locations (specified by the entire range of RF quadrupole voltages that can be used). Windows with the highest mass acquired are defined by the maximum RF which can be delivered to Q0 rods.

This large matrix of possible Q0 precursor ion mass selection window locations and widths means that is it possible to use the rods and T-bars of a Q0 multipole ion guide Q0 to create the different windows required for a DIA method. In a DIA method, a Q0 precursor ion mass selection window is moved or stepped across a mass range. As a result, the location of the window specified by the RF quadrupole voltage is constantly changing. Line 1020, for example, shows that different DC T-bar voltage values are available to move (by increasing the RF quadrupole voltage) a fixed Q0 precursor ion mass selection window of width 150 Da across a mass range.

In a DIA method, precursor ion mass selection window width can increase as a window is moved across the mass range. Line 1030, for example, shows that different DC T-bar voltage values are available to move a Q0 precursor ion mass selection window that increases in width from 100 Da to 250 Da as the window is moved across a mass range.

Finally, in a DIA method, a precursor ion mass selection window can have different widths at different mass locations. Curve 1040, for example, shows that different DC T-bar voltage values are available to move a Q0 precursor ion mass selection window that has a width that starts at 450 Da at the beginning of a mass range, decreases to 150 Da in the middle of the mass range, and increases back to 450 Da at the end of the mass range.

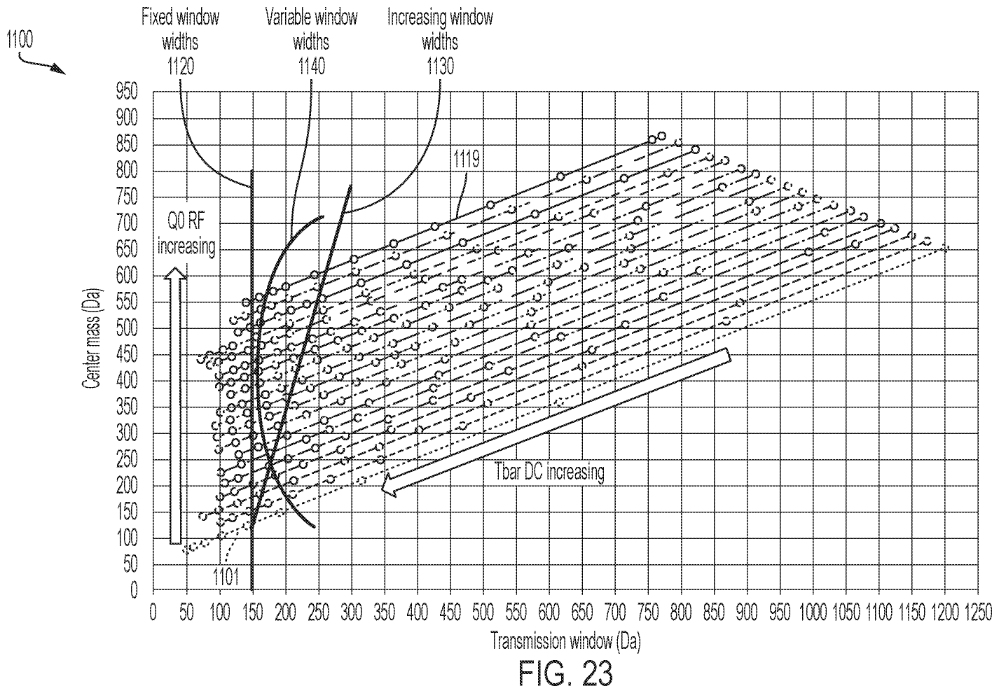

FIG. 23 is an exemplary plot 1100 of the same data shown in FIG. 22 showing the different center mass locations and widths that can be produced using a multipole ion guide Q0 that includes quadrupole rods and T-bars interposed between them, in accordance with various embodiments. Plot 1100 shows that varying the voltages applied to the T-bars and the rods of a quadrupole Q0 can produce a wide selection of Q0 precursor ion mass selection window widths and center mass locations.

In plot 1100, the different lines connecting data points represent increasing RF voltages (Vp-p, 19 voltages from 200 to 2000 V in increasing increments of 100 V) applied to quadrupole rods. For example, line 1101 connects the values measured when an RF voltage of 200 V is applied to the quadrupole rods of the Q0 multipole ion guide Q0. Similarly, line 1119 connects the values measured when an RF voltage of 2000 V is applied to the quadrupole rods of the multipole ion guide Q0.

The points connected by the RF voltage lines in plot 1100 represent different DC T-bar voltages. Within each RF voltage line, the DC T-bar voltage is increasing from the right-hand side of the plot to the left-hand side.

Like FIG. 22, plot 1100 of FIG. 23 shows a large matrix of possible Q0 precursor ion mass selection window locations and widths. This, again, indicates that it is possible to use the rods and T-bars of a multipole ion guide Q0 to create the different windows required for a DIA method. Line 1120, line 1130, and curve 1140 show that different DC T-bar voltage values are available to move (along with increasing the RF quadrupole voltage) a Q0 precursor ion mass selection window that has fixed, increasing, and variable widths, respectively.

### (2) Reproducibility of Windows

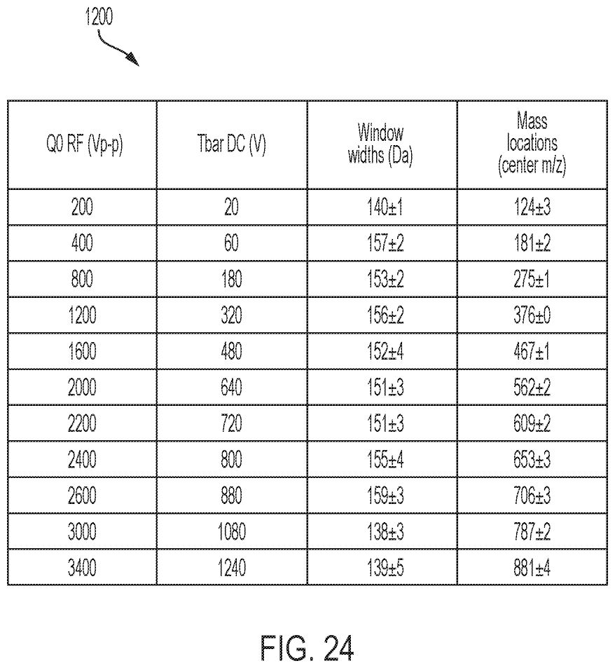

FIG. 24 is an exemplary table 1200 showing different RF quadrupole rod voltages and DC T-bar voltages applied to quadrupole rods and T-bars, respectively, of a multipole ion guide Q0 to produce a 150 Da Q0 precursor ion mass selection window at different mass locations, in accordance with various embodiments. Table 1200 shows that the window width is reproducible for all eleven different center mass locations.

### (3) Consistency for a Range of Different Compounds

A reserpine sample, a mixture of 211 known compounds, and a bovine serum albumin (BSA) digest were analyzed using a multipole ion guide Q0 that includes quadrupole rods and T-bars interposed between them. A 2000 Vₚ₋ₚ RF quadrupole rod voltage was applied to the quadrupole rods, and a 640 V DC T-bar voltage was applied to the T-bars. These voltages produced Q0 precursor ion mass selection window widths of 151 Da, 157 Da, and 145 Da for the reserpine sample, the mixture of 211 known compounds, and the BSA digest, respectively. These results show that a multipole ion guide Q0 that includes quadrupole rods and T-bars can produce consistent Q0 precursor ion mass selection window widths across a range of different compounds with different charge states.

### (4) Ion Current Magnitude Independence

A mixture of 211 known compounds prepared in five different dilutions (×2, ×10, ×100, ×1000, and ×10000) was analyzed using a multipole ion guide Q0 that includes quadrupole rods and T-bars interposed between them. The Q0 precursor ion mass selection windows used did not shift among the different concentrations of the mixture used even though these concentrations varied across multiple orders of magnitude. As a result, the Q0 precursor ion mass selection windows were found to be independent of ion current intensity.

### (5) Q0 Refill Time

In a multipole ion guide Q0 that includes quadrupole rods and T-bars interposed between them, the region between the Q0/T-bars and the next mass spectrometer component contains only ions within the specific window which has been selected. When that window changes, time is needed to repopulate the region downstream of the T-bars with the new ions. From the preliminary tests, a Q0 refill time of <5 ms (considering a 3 ms cycle time) was estimated.

In a typical DIA method, the accumulation time for each precursor ion mass selection window is in a range of 50 ms to 100 ms. As a result, a multipole ion guide Q0 that includes quadrupole rods and T-bars can be used without substantially affecting the Q1 scan speed and the cycle time.

In the preliminary tests, the RF quadrupole rod voltage was fixed, only the DC T-bar voltage was changed to generate two Q0 precursor ion mass selection windows. An MRM was run with a 2 ms dwell time and 1 ms pause time. The Q0 refill time was estimated from the rise time of the 2nd window ion intensity. Note that the DC T-bar voltage can be changed quickly using, for example, a commercial lens amplifier (750 V lenses), with rise and fall times of ˜180 us and ˜50 μs, respectively, for a full DC swing from −750 Vdc to +750 Vdc at the output of the lens module.

### Q1 Synchronized Prefilter

In various embodiments, Q0 precursor ion mass selection windows can be coupled to Q1 precursor ion mass selection windows, to simultaneously filter out unwanted ions outside of the Q1 precursor m/z range. To achieve this, a Q0 multipole ion guide with a multipole rod set and auxiliary electrodes is operated as shown in FIG. 16.

In a conventional DIA method, the Q1 precursor ion mass selection windows are calibrated based on a Q1 RF voltage and a DC resolution offset voltage, where the RF voltage defines the low m/z cut-off and the DC voltage defines the window widths. In scanning SWATH®, for example, the precursor Q1 windows are controlled by a scanning Q1 RF voltage with a fixed DC resolution offset voltage.

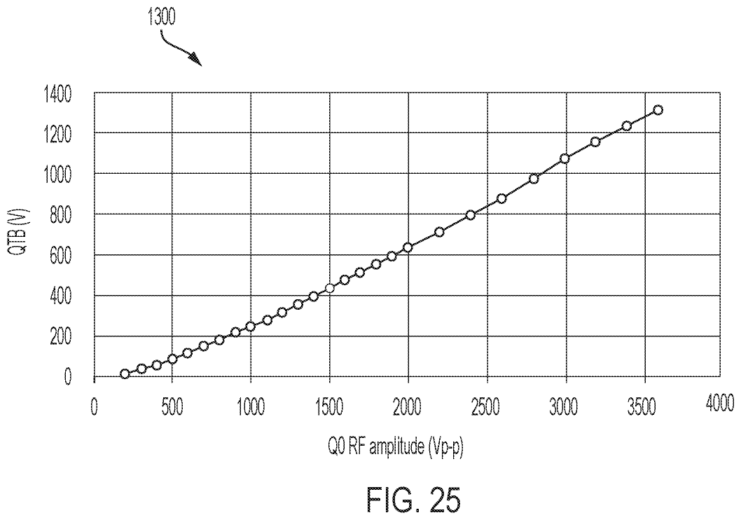

FIG. 25 is an exemplary plot 1300 showing how the DC voltage applied to auxiliary electrodes of a multipole ion guide Q0 varies with the RF voltage applied to the multipole rod set of the multipole ion guide Q0 in order to maintain a constant Q0 precursor ion mass selection window width, in accordance with various embodiments. A 150 Da Q0 precursor ion mass selection window width is maintained as the RF voltage applied to the multipole rod set of the Q0 multipole ion guide is increased. Plot 1300 shows the DC voltages (QTB) that are applied to the auxiliary electrodes of a multipole ion guide Q0 in order to maintain the 150 Da window width as the RF voltage is increased.

It will be apparent to those of skill in the relevant arts that narrower Q0 precursor ion mass selection window widths may be selected using alternate ion guide bandpass approaches such as a segmented Q0 with RF and DC potentials applied thereto.

Plot 1300 shows that, in a multipole ion guide Q0 with a multipole rod set and auxiliary electrodes, the DC voltage (QTB) applied to auxiliary electrodes, for a given mass window high m/z cut-off, scales linearly with the RF voltage applied to the multipole rod set. For a given RF voltage, various window widths can be achieved by adjusting tee bar DC voltages, which determine the high m/z cut-offs. Therefore, it is possible to achieve Q0 precursor ion mass selection windows with widths and mass location synchronized with Q1 precursor ion mass selection windows, as shown in FIG. 16.

Both the low mass side and the high mass side of the Q0 precursor ion mass selection window can be synchronized with a Q1 precursor ion mass selection window. The low mass cut-offs are linked through synchronizing the RF voltage on Q1 and Q0 rods. This can be achieved using either one RF generator as in standard instruments or by using separate RF generators. In a standard instrument, one RF power supply is used, and the Q0 RF signal is capacitively coupled to the Q1 RF signal. As a result, RF voltage changes on Q0 and Q1 are synchronized, and, for example, on standard instruments, the Q0 RF signal amplitude is approximately ⅔ of the Q1 RF signal amplitude.

This difference allows the ion guide Q0 to transmit ions from a lower mass as compared with the mass filter Q1 (the difference may be ˜100 to 200 Da in this case). When the ion guide Q0 is controlled by a separate power supply, the Q0 RF voltage can be linked-to the Q1 RF voltage based on the power supply frequency and window settings (low mass side) from DIA methods. The Q0 RF voltage can be set to create a low mass cut-off which is slightly lower than the low mass end in a Q1 window (e.g., by dropping the Q0 RF amplitude by a certain offset).

The Q0 precursor ion mass selection windows on the high mass side can be linked to Q1 precursor ion mass selection windows by controlling the DC voltage of the auxiliary electrodes. Since the dependence of the DC voltage of the auxiliary electrodes on mass location and window width when using the ion guide Q0 as a bandpass filter was mapped out, as shown in FIG. 22 and FIG. 23, it is possible to set the DC voltage of the auxiliary electrodes to achieve the desired bandpass windows based on the mass window settings in DIA methods.

The DC voltage can be adjusted to bandpass ions with an m/z slightly higher than the high mass end in a Q1 window. As precursor windows are stepped from low to high mass, the DC voltages increase along with increasing RF voltage. The voltage values can be automatically set based on window settings in a DIA method, enabling synchronization of Q0 bandpass windows to Q1 precursor windows in a DIA cycle. The width of the bandpass windows will depend on which Q0 bandpass approach is used.

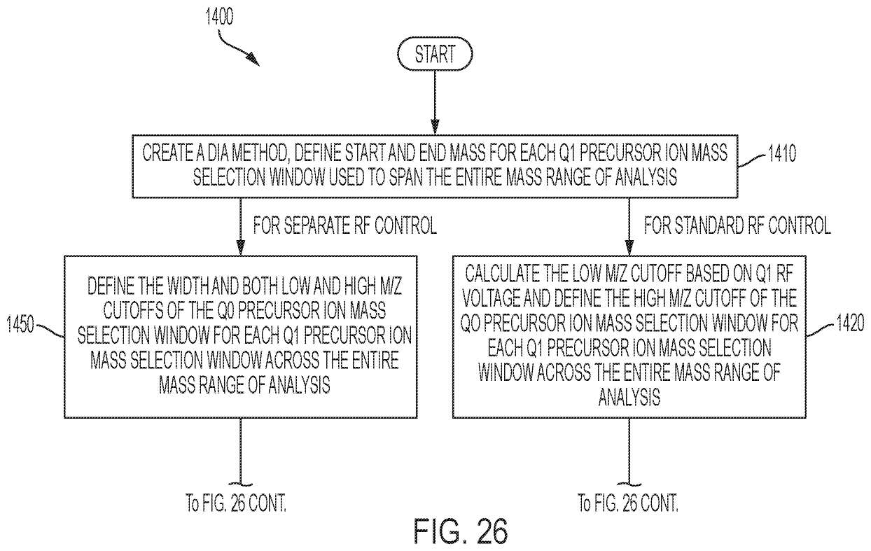

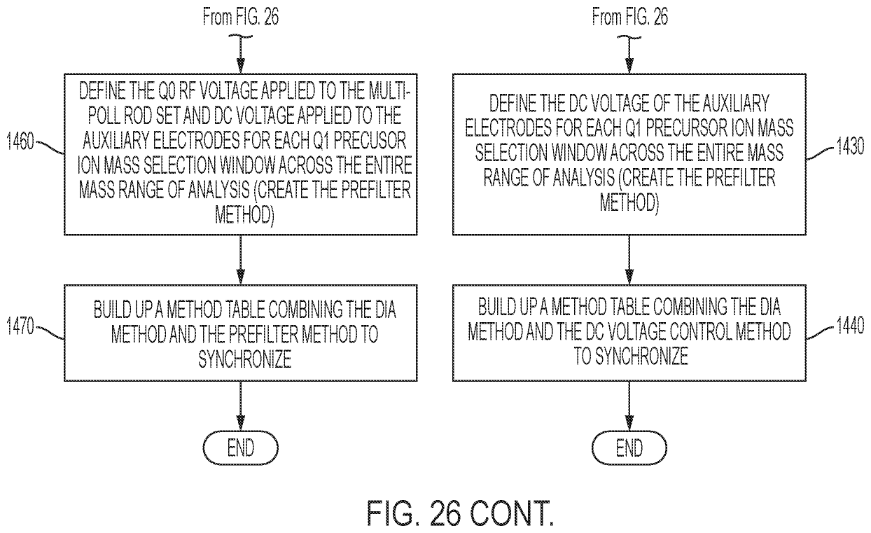

FIG. 26 is an exemplary flowchart showing a method 1400 for synchronizing Q0 precursor ion mass selection windows with Q1 precursor ion mass selection windows, in accordance with various embodiments. In step 1410 of the method 1400, a DIA method is created, and start and end masses for each Q1 precursor ion mass selection window used to span the entire mass range of analysis are defined.

If a standard method of RF control is used, step 1410 moves to step 1420. In step 1420, the low m/z cutoff is calculated based on the Q1 RF voltage, and the high m/z cutoff of the Q0 precursor ion mass selection window is defined for each Q1 precursor ion mass selection window across the entire mass range of analysis.

In step 1430, the DC voltage of the auxiliary electrodes is defined for each Q1 precursor ion mass selection window across the entire mass range of analysis (the prefilter method is created). In step 1440, the method table is built up by combining the DIA method and the DC voltage control method to synchronize.

If a separate RF control is used, step 1410 moves to step 1450. In step 1450, the width and both low and high m/z cutoffs of the Q0 precursor ion mass selection window are defined for each Q1 precursor ion mass selection window across the entire mass range of analysis.

In step 1460, the Q0 RF voltage applied to the multipolar rod set and the DC voltage applied to the auxiliary electrodes are defined for each Q1 precursor ion mass selection window across the entire mass range of analysis (the prefilter method is created).

The separate RF control of method 1400 allows more flexibility in controlling Q0 precursor ion mass selection windows on the low mass side and how much wider these windows are than the Q1 precursor ion mass selection windows. Conventional DIA methods apply Q1 windows in a range from 5 to 50 Da. In various embodiments, Q0 windows are given a width of 150 Da and the Q1 window is placed in the center of this 150 Da window for best performance. When one RF generator is used for applying RF voltages to both Q0 and Q1, though the low-mass cut off differences between Q0 and Q1 is not adjustable (˜ 100 to 200 Da), the DC potentials can be set to transfer a wider Q0 window such as 300 Da to ensure the Q1 window is covered.

In scanning SWATH® operational mode, the Q1 RF voltage is scanned with a fixed resolution offset, to produce windows which gradually become larger as scanning moves from low to high mass. In various embodiments, the Q0 RF voltage is scanned simultaneously with the Q1 RF voltage, and the DC voltage applied to the Q0 auxiliary electrodes changes with the Q0 RF voltage to increase the width of Q0 windows as the windows are moved. Examples of windows with increasing window width as they are moved are shown in FIGS. 22 and 23.

One advantage of various embodiments is flexible control on the high m/z cutoff of Q0 precursor ion mass selection windows. As shown in FIGS. 22 and 23, the window widths can be controlled to a fixed value across the entire mass range, or be changed in an increasing/decreasing order, or customized to variable windows based on DIA methods. For example, many applications use variable precursor ion mass selection windows optimized to transmit high-intensity m/z ranges using small windows and low-intensity m/z ranges using large windows as an approach to balance sensitivity and selectivity. The example flow chart of FIG. 26 specifically refers to the embodiment where Q0 tee bars are used to create the bandpass. It will be apparent to those of skill in the relevant arts that the present teachings relate to any method of creating a bandpass in the higher pressure region or regions upstream of a first mass analyzer. The specific steps of the flow chart in FIG. 26 will vary for different bandpass approaches.

### System for Mass Filtering Precursor Ions in a DIA Method

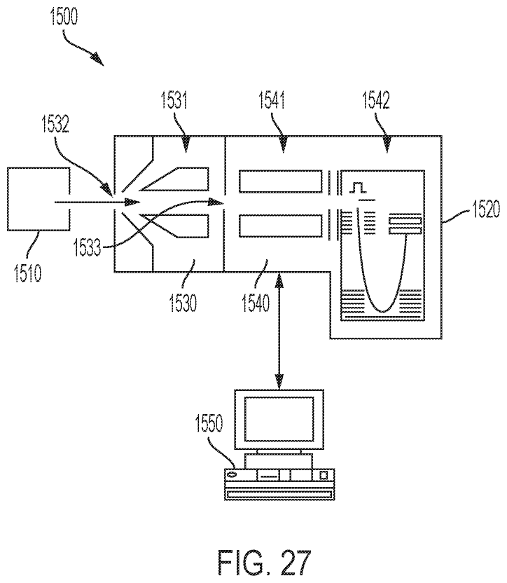

FIG. 27 is a schematic diagram 1500 showing a system for mass filtering precursor ions in a DIA method using a multipole ion guide mass filter, in accordance with various embodiments. The system of FIG. 27 includes ion source device 1510, tandem mass spectrometer 1520, and processor 1550.

Ion source device 1510 ionizes one or more compounds of a sample, producing an ion beam. Ion source device 1510 is shown as a device separate from tandem mass spectrometer 1520. In various alternative embodiments, ion source device 1510 is a component of tandem mass spectrometer 1520. Ion source device 1510 can be any ion source known in the art, including, but not limited to, an electrospray ion source (ESI) device or a chemical ionization (CI) source device such as an atmospheric pressure chemical ionization source (APCI) device or an atmospheric pressure photoionization (APPI) source device.

Tandem mass spectrometer 1520 includes ion guide chamber 1530 and multipole ion guide 1531 disposed in ion guide chamber 1530. Ion guide chamber 1530 includes inlet orifice 1532 for receiving the ions generated by ion source device 1510 and at least one exit aperture 1533 for transmitting ions from ion guide chamber 1530 into vacuum chamber 1540 housing at least one fragmentation device 1541.

In the system of FIG. 27, tandem mass spectrometer 1520 also includes time-of-flight (TOF) mass analyzer 1542, which is positioned in vacuum chamber 1540. One of ordinary skill in the art can appreciate that any component of tandem mass spectrometer 1520 can include other types of mass spectrometry devices including, but not limited to, ion traps, orbitraps, quadrupole devices, ion mobility devices, or Fourier transform ion cyclotron resonance (FT-ICR) devices. This may also include additional pumping stages and ion guides.

Processor 1550 receives a plurality of different precursor ion mass selection windows spanning a precursor ion mass range selected for a DIA method. Processor 1550 calculates two or more different multipole ion guide precursor ion mass selection windows for transmission during the same time cycle of tandem mass spectrometer 1520 from the plurality of different precursor ion mass selection windows.

During each cycle time of a plurality of time cycles of tandem mass spectrometer 1520, for each selection window of the plurality of different precursor ion mass selection windows, processor 1550 instructs multipole ion guide 1531 to transmit precursor ions from the ion beam within a multipole ion guide precursor ion mass selection window of the two or more different multipole ion guide precursor ion mass selection windows. The multipole ion guide precursor ion mass selection window has a width greater than or equal to the width of the selection window and includes the mass range of the selection window.

In various embodiments, multipole ion guide 1531 is the only mass filter of tandem mass spectrometer 1520. The two or more different multipole ion guide precursor ion mass selection windows calculated for transmission during each cycle time are the plurality of different precursor ion mass selection windows. Multipole ion guide 1531 transmits the precursor ions from the ion beam directly to at last one fragmentation device 1541 of tandem mass spectrometer 1520. During each cycle time of a plurality of time cycles of the tandem mass spectrometer, for each selection window of the plurality of different precursor ion mass selection windows, processor 1550 further instructs multipole ion guide 1531 to transmit precursor ions from the ion beam within a multipole ion guide precursor ion mass selection window of the two or more different multipole ion guide precursor ion mass selection windows that has a width equal to the width of the selection window, as shown in FIG. 15.

In various embodiments, processor 1550 instructs multipole ion guide 1531 to transmit precursor ions by applying to multipole ion guide 1531 an RF electrical voltage to specify a low m/z cutoff of the multipole ion guide precursor ion mass selection window and a DC electrical voltage to specify a high m/z cutoff of the multipole ion guide precursor ion mass selection window.

In various embodiments, multipole ion guide 1531 includes a rod set and a plurality of auxiliary electrodes like the multipole ion guide of FIG. 19. The rod set includes a first group of rods and a second group of rods. Each rod is spaced from and extends alongside a central longitudinal axis. The plurality of auxiliary electrodes is also spaced from and extends alongside the central longitudinal axis along at least a portion of the rods of the rod set. At least one auxiliary electrode of the plurality of auxiliary electrodes is interposed between each of the rods of the rod set such that each of the auxiliary electrodes is adjacent to a single rod of the first group of rods and a single rod of the second group of rods.

Processor 1550 further applies the voltage of the RF electrical signal to the rod set to specify the low m/z cutoff of the multipole ion guide precursor ion mass selection window. Processor 1550 applies the DC electrical voltage to the plurality of auxiliary electrodes to specify the high m/z cutoff of the multipole ion guide precursor ion mass selection window.

In various embodiments, multipole ion guide 1531 includes a segmented rod set like the multipole ion guide of FIG. 18. Each rod of the segmented rod set is spaced from and extends alongside a central longitudinal axis. Each rod of the segmented rod set is also segmented into the same three or more different longitudinal segments. These different longitudinal segments include at least a first segment for receiving ions entering the multipole ion guide, a final segment for transmitting ions from the multipole ion guide, and a middle segment located between the first segment and the final segment.

Processor 1550 further applies the voltage of the RF electrical signal to rod segments of the bandpass segment to specify the low m/z cutoff of the multipole ion guide precursor ion mass selection window. Processor 1550 applies the DC electrical voltage to the rod segments of the middle segment to specify the high m/z cutoff of the multipole ion guide precursor ion mass selection window.

In various embodiments, multipole ion guide 1531 is a non-segmented rod set and does not include auxiliary electrodes. However, in general, non-segmented ion guides alone with RF/DC are not effective at band passing at the pressures currently used. Ions can have a wide range of radial amplitudes at the entrance of the ion guide. Thus, a single RF/DC combination filters ions based on their radial position values. As a result, there is likely a dramatic loss of ion intensity with increasing resolving DC values. This is different with collisionally cooled ions, such as those produced in a segmented ion guide.

In various embodiments, multipole ion guide 1531 can be configured as a prefilter for a mass filter device (not shown) of tandem mass spectrometer 1520. Tandem mass spectrometer 1520, for example, can further include a mass filter device that is positioned between multipole ion guide 1531 and fragmentation device 1541. The mas filter can be located in vacuum chamber 1540, for example. Multipole ion guide 1531 further transmits the precursor ions from the ion beam directly to the mass filter device.

During each cycle time of a plurality of time cycles of the tandem mass spectrometer, for each selection window of the plurality of different precursor ion mass selection windows, processor 1550 further instructs multipole ion guide 1531 to transmit precursor ions from the ion beam within a multipole ion guide precursor ion mass selection window of the two or more different multipole ion guide precursor ion mass selection windows that has a width greater than the width of each selection window. Processor 1550 instructs the mass filter device to transmit precursor ions received from multipole ion guide 1531 within each selection window.

In various embodiments, the RF electrical signal received by multipole ion guide 1531 is capacitively coupled to the RF electrical signal received by the mass filter device. Specifically, processor 1550 can apply an RF electrical voltage to the multipole ion guide that is capacitively coupled to an RF signal received by the mass filter device for each selection window. This is done so that the voltage of the RF electrical signal received by multipole ion guide 1531 specifies a low m/z cutoff for each selection window that is the same as or a fraction of a voltage of the RF signal received by the mass filter device for each selection window.

In various embodiments, the RF electrical voltage received by multipole ion guide 1531 is a fraction of the RF electrical voltage received by the mass filter device. Specifically, the RF voltage applied to multipole ion guide 1531 for each selection window is capacitively coupled with an RF signal received by the mass filter device for each selection window. This is done so that the RF electrical voltage received by the multipole ion guide specifies a low m/z cutoff for each selection window that is a fraction of a voltage of the RF signal received by the mass filter device for each selection window. Also, the low m/z cutoff for each selection window in multipole ion guide 1531 has a lower m/z value than a low m/z cutoff for each selection window in the mass filter device.

In various embodiments, multipole ion guide 1531 and the mass filter device have different RF signal sources. Specifically, processor 1550 applies the voltage of the RF electrical signal to multipole ion guide 1531 by applying a voltage of an RF electrical signal to multipole ion guide 1531 that is from a different signal source than an RF signal received by the mass filter device for each selection window.

In various embodiments, one multipole ion guide precursor ion mass selection window can be used for two or more different precursor ion mass selection windows as shown in FIG. 17. Specifically, processor 1550 instructs multipole ion guide 1531 to transmit precursor ions using the same multipole ion guide precursor ion mass selection window of two or more different multipole ion guide precursor ion mass selection windows for at least two different selection windows of the plurality of different precursor ion mass selection windows.

In various embodiments, processor 1550 calculates the two or more different multipole ion guide precursor ion mass selection windows using a lookup table. The lookup table, for example, is derived from experimental data like the data shown in FIGS. 22 and 23.

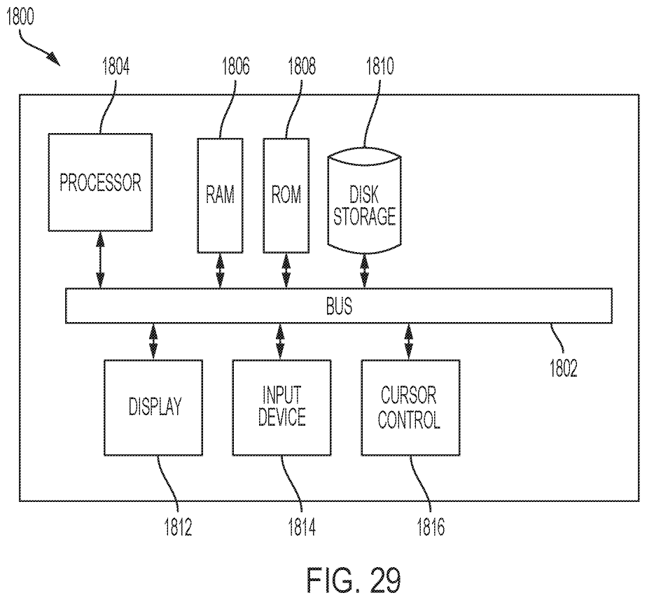

Processor 1550 can be, but is not limited to, a computer, a microprocessor, the computer system of FIG. 29, or any device capable of sending and receiving control signals and data from a tandem mass spectrometer and processing data. Processor 1550 is in communication with ion source device 1510 and tandem mass spectrometer 1520. Processor 1550 is shown as a separate device but can be a processor or controller of tandem mass spectrometer 1520 or another device. Processor 1550 controls or instructs tandem mass spectrometer 1520 or its components, for example, by controlling a one or more voltage sources, one or more valves, or one or more pumps (not shown) of tandem mass spectrometer 1520.

### Method for Mass Filtering Precursor Ions in a DIA Method

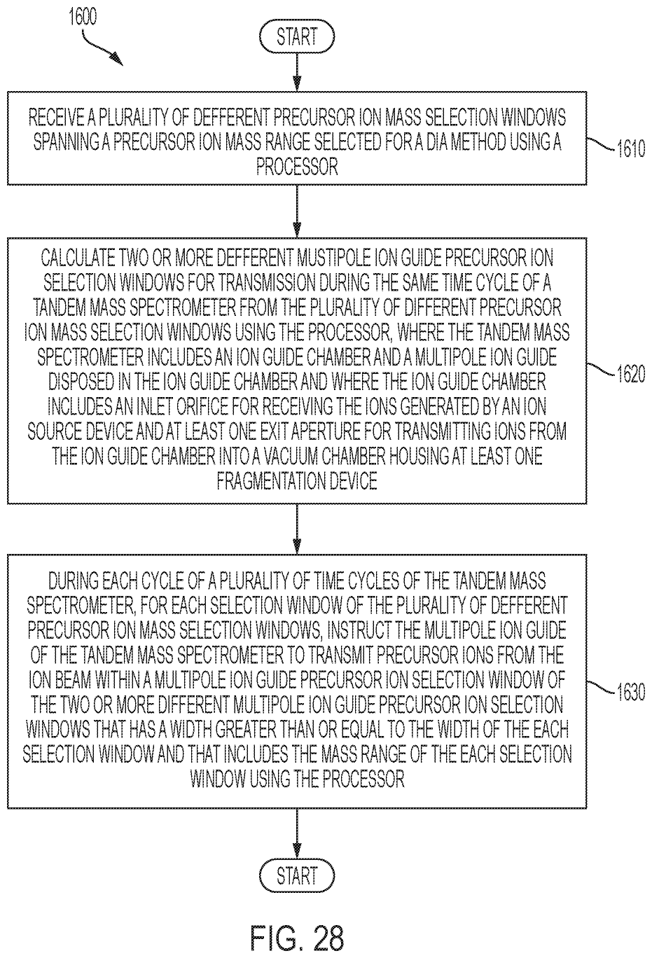

FIG. 28 is a flowchart showing a method 1600 for mass filtering precursor ions in a DIA method using a multipole ion guide mass filter, in accordance with various embodiments. In step 1610 of method 1600, a plurality of different precursor ion mass selection windows spanning a precursor ion mass range selected for a DIA method is received using a processor. In step 1620, two or more different multipole ion guide precursor ion mass selection windows are calculated for transmission during the same time cycle of a tandem mass spectrometer from the plurality of different precursor ion mass selection windows using the processor. The tandem mass spectrometer includes an ion guide chamber and a multipole ion guide disposed in the ion guide chamber. The ion guide chamber includes an inlet orifice for receiving the ions generated by an ion source device and at least one exit aperture for transmitting ions from the ion guide chamber into a vacuum chamber housing at least one fragmentation device. In step 1630, during each cycle of a plurality of time cycles of the tandem mass spectrometer, for each selection window of the plurality of different precursor ion mass selection windows, a multipole ion guide of the tandem mass spectrometer is instructed to transmit precursor ions from the ion beam within a multipole ion guide precursor ion mass selection window of the two or more different multipole ion guide precursor ion mass selection windows using the processor. The multipole ion guide precursor ion mass selection window has a width greater than or equal to the width of each selection window and includes the mass range of each selection window.

### Computer-Implemented System

FIG. 29 is a block diagram that illustrates a computer system 1800, upon which embodiments of the present teachings may be implemented. Computer system 1800 includes a bus 1802 or other communication mechanism for communicating information, and a processor 1804 coupled with bus 1802 for processing information. Computer system 1800 also includes a memory 1806, which can be a random-access memory (RAM) or other dynamic storage device, coupled to bus 1802 for storing instructions to be executed by processor 1804. Memory 1806 also may be used for storing temporary variables or other intermediate information during execution of instructions to be executed by processor 1804. Computer system 1800 further includes a read only memory (ROM) 1808 or other static storage device coupled to bus 1802 for storing static information and instructions for processor 1804. A storage device 1810, such as a magnetic disk or optical disk, is provided and coupled to bus 1802 for storing information and instructions.

Computer system 1800 may be coupled via bus 1802 to a display 1812, such as a cathode ray tube (CRT) or liquid crystal display (LCD), for displaying information to a computer user. An input device 1814, including alphanumeric and other keys, is coupled to bus 1802 for communicating information and command selections to processor 1804. Another type of user input device is cursor control 1816, such as a mouse, a trackball or cursor direction keys for communicating direction information and command selections to processor 1804 and for controlling cursor movement on display 1812. This input device typically has two degrees of freedom in two axes, a first axis (i.e., x) and a second axis (i.e., y), that allows the device to specify positions in a plane.

In some embodiments, the computer system 1800 can be employed to implement the present teachings. Consistent with certain implementations of the present teachings, results are provided by computer system 1800 in response to processor 1804 executing one or more sequences of one or more instructions contained in memory 1806. Such instructions may be read into memory 1806 from another computer-readable medium, such as storage device 1810. Execution of the sequences of instructions contained in memory 1806 causes processor 1804 to perform the process described herein. Alternatively, hard-wired circuitry may be used in place of or in combination with software instructions to implement the present teachings. Thus, implementations of the present teachings are not limited to any specific combination of hardware circuitry and software.

In various embodiments, computer system 1800 can be connected to one or more other computer systems, like computer system 1800, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 1804 for execution. Such a medium may take many forms, including but not limited to, non-volatile media, volatile media, and transmission media. Non-volatile media includes, for example, optical or magnetic disks, such as storage device 1810. Volatile media includes dynamic memory, such as memory 1806. Transmission media includes coaxial cables, copper wire, and fiber optics, including the wires that comprise bus 1802.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 1804 for execution. For example, the instructions may initially be carried on the magnetic disk of a remote computer. The remote computer can load the instructions into its dynamic memory and send the instructions over a telephone line using a modem. A modem local to computer system 1800 can receive the data on the telephone line and use an infra-red transmitter to convert the data to an infra-red signal. An infra-red detector coupled to bus 1802 can receive the data carried in the infra-red signal and place the data on bus 1802. Bus 1802 carries the data to memory 1806, from which processor 1804 retrieves and executes the instructions. The instructions received by memory 1806 may optionally be stored on storage device 1810 either before or after execution by processor 1804.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Computer Program Product for Filtering Precursor Ions in a DIA Method

In various embodiments, computer program products include a tangible computer-readable storage medium whose contents include a program with instructions being executed on a processor so as to perform a method for mass filtering precursor ions in a DIA method using a multipole ion guide mass filter. This method is performed by a system that includes one or more distinct software modules.

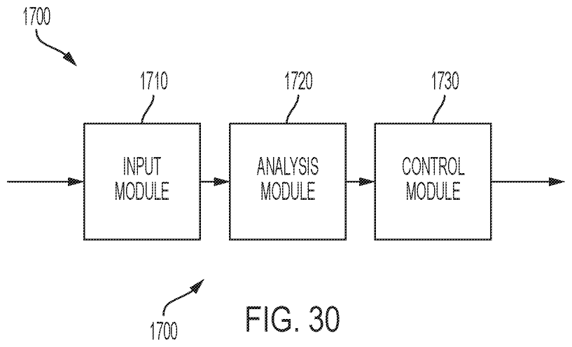

FIG. 30 is a schematic diagram of a system 1700 that includes one or more distinct software modules that perform a method for mass filtering precursor ions in a DIA method using a multipole ion guide mass filter, in accordance with various embodiments. System 1700 includes an input module 1710, an analysis module 1720, and a control module 1730

Input module 1710 receives a plurality of different precursor ion mass selection windows spanning a precursor ion mass range selected for a DIA method. Analysis module 1720 calculates two or more different multipole ion guide precursor ion mass selection windows for transmission during the same time cycle of a tandem mass spectrometer from the plurality of different precursor ion mass selection windows. The tandem mass spectrometer includes an ion guide chamber and a multipole ion guide disposed in the ion guide chamber. The ion guide chamber includes an inlet orifice for receiving the ions generated by an ion source device and at least one exit aperture for transmitting ions from the ion guide chamber into a vacuum chamber housing at least one fragmentation device.

Control module 1730, during each cycle of a plurality of time cycles of a tandem mass spectrometer, for each selection window of the plurality of different precursor ion mass selection windows, instructs a multipole ion guide of the tandem mass spectrometer to transmit precursor ions from the ion beam within a multipole ion guide precursor ion mass selection window of the two or more different multipole ion guide precursor ion mass selection windows that has a width greater than or equal to the width of each selection window and that includes the mass range of each selection window.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

Those having ordinary skill in the art will appreciate that various changes can be made to the above embodiments without departing from the scope of the invention

1. A mass spectrometer, comprising:
a first mass filter for receiving a plurality of precursor ions and having a transmission bandwidth configured to allow transmission of ions having m/z ratios within a desired range;
a second mass filter disposed downstream of said first mass filter for selecting ions having a target m/z ratio within a transmission window thereof for mass analysis; and
a controller coupled to said first mass filter for setting the transmission bandwidth of said first mass filter so as to encompass at least two m/z ratios such that at least one of said m/z ratios is within the transmission window of said second mass filter,
wherein the controller is configured to change the transmission bandwidth of the first mass filter over time such that any two consecutive transmission bandwidths of said first mass filter have at least one m/z ratio in common.

2. The mass spectrometer of claim 1, wherein said controller is coupled to said second mass filter for moving said transmission window of said second mass filter for selecting a different target m/z ratio.

3. The mass spectrometer of claim 2, wherein said controller is configured to correlate time-variation of the transmission bandwidth of said first mass filter with time variation of said transmission window of said second mass filter so as to allow mass analysis of ions having different m/z ratios transmitted through said first mass filter by said second mass filter as the transmission bandwidth of said first mass filter is shifted over time.

4. The mass spectrometer of claim 3, wherein said controller is configured to set the ion transmission bandwidth of said first mass filter to an initial ion transmission bandwidth and to set the ion transmission window of said second mass filter so as to allow passage of ions having an m/z ratio encompassed by said initial bandwidth of said first mass filter.

5. The mass spectrometer of claim 1, wherein said controller is configured to adjust the transmission window of said second mass filter to capture a next m/z ratio of interest and to shift the ion transmission bandwidth of said first mass filter to cover said next m/z ratio and another m/z ratio of interest.

6. The mass spectrometer of claim 2, wherein said controller is further configured to adjust the transmission window of said second mass filter and shift the transmission bandwidth of said first mass filter substantially concurrently.

7. The mass spectrometer of claim 2, wherein said controller is configured to shift the ion transmission window of said second mass filter prior to adjusting the ion transmission bandwidth of said first mass filter.

8. The mass spectrometer of claim 2, wherein said controller is configured to shift the ion transmission bandwidth of said first mass filter while said second mass filter monitors ions having an m/z ratio covered by the transmission bandwidth of said first mass filter prior to the shift thereof.

9. The mass spectrometer of claim 1, wherein said controller is configured to set the transmission bandwidth of said first mass filter to allow transmission of ions having three or more m/z ratios.

10. The mass spectrometer of claim 1, wherein the transmission bandwidth of any of the first mass filter and the second mass filter is less than about 2000 Da.

11. The mass spectrometer of claim 1, further comprising an ion source positioned upstream of said first mass filter for generating said plurality of precursor ions.

12. The mass spectrometer of claim 1, wherein any of said first mass filter and said second mass filter comprises at least one set of rods arranged in a multipole configuration to at least one of which one or more RF voltages can be applied for providing radial confinement of the ions and to at least one of which a DC resolving voltage can be applied for generating said transmission bandwidth thereof, and wherein said multipole configuration optionally comprises a quadrupole configuration.

13. The mass spectrometer of claim 12, wherein said at least one set of rods comprises multiple sets of rods positioned in series, wherein each rod set comprises a plurality of rods arranged in a multipole configuration, and wherein optionally a DC voltage offset is applied between at least two of said rod sets so as to generate an electric field for accelerating ions passing through said first mass filter, and wherein optionally said DC voltage offset is in a range of about 0 volt to about 200 volts.

14. The mass spectrometer of claim 1, wherein said transmission bandwidth of the first mass filter has an m/z width greater than an m/z width of the transmission bandwidth of the second mass filter.

15. The mass spectrometer of claim 1, wherein said first and second mass filters are located in separate differentially pumped vacuum chambers.

16. The mass spectrometer of claim 15, wherein a pressure differential between said two separate differentially pumped vacuum chambers is in a range of about 10× to about 50×.

17. The mass spectrometer of claim 16, wherein the second mass filter is positioned downstream of the first mass filter and maintained at a lower pressure chamber.

18. A system for performing a data-independent acquisition (DIA) method for mass spectrometry, comprising:
a first mass filter for receiving a plurality of precursor ions;
a second mass filter disposed downstream of said first mass filter for receiving ions exiting said first mass filter; and
a controller operably coupled to said first mass filter and said second mass filter to configure the second mass filter to provide a plurality of ion selection windows over a DIA mass analysis cycle such that said mass selection windows collectively span a precursor ion mass range associated with the DIA analysis,
wherein said controller further configures the first mass filter to provide a plurality of ion transmission bandwidths such that each of said ion transmission bandwidths is configured to prefilter the precursor ions for at least one respective one of said ion selection windows of the second mass filter such that each of the ion transmission bandwidths of the first mass filter has an m/z width greater than an m/z width of said one respective ion selection window of the second mass filter.

19. The system of claim 18, wherein at least one of said ion transmission bandwidths of the first mass filter has a lower low m/z cutoff and a higher high m/z cutoff than a respective low m/z cutoff and high m/z cutoff of said at least one respective ion selection window of the second mass filter.

20. The system of claim 18, wherein said at least one respective ion selection window of said second mass filter comprises at least two consecutive ion selection windows.

21-42. (canceled)
